(19) United States
(12) Patent Application Publication
(10) Pub. No.: US 2026/0268583 A1
(43) Pub. Date: Sep. 10, 2026

(54) IMAGE PROCESSING DEVICE, IMAGE PROCESSING METHOD, AND DATA STRUCTURE OF 3D SCENE INFORMATION FOR DISPLAY

(71) Applicant: Sony Interactive Entertainment Inc., Tokyo (JP)

(72) Inventor: Takayuki Shinohara, Tokyo (JP)

(73) Assignee: Sony Interactive Entertainment Inc., Tokyo (JP)

(21) Appl. No.: 19/663,105

(22) Filed: Apr. 29, 2026

Related U.S. Application Data
(63) Continuation of application No. PCT/JP2023/039247, filed on Oct. 31, 2023.

(51) Int. Cl. G06T 15/08; A63F 13/525; G06T 11/60

(52) U.S. Cl. CPC G06T 15/08; A63F 13/525; G06T 11/60

(57) ABSTRACT

An additional viewpoint setting unit of a content server acquires viewpoint restriction information from an application execution unit, and sets viewpoints for generating training images within a restriction range. The application execution unit generates images of a display world in correspondence with the set viewpoints. A three-dimensional (3D) scene information generation unit performs machine learning on the basis of the images generated by the application execution unit to generate 3D scene information associated with the display world. An arbitrary viewpoint image generation unit acquires viewpoint restriction information from the application execution unit, and generates images indicating the display world on the basis of arbitrary viewpoints within the restriction range.

### CROSS-REFERENCE TO RELATED APPLICATION

This application in a continuation of International Application No. PCT/JP2023/039247, filed Oct. 31, 2023, entitled “IMAGE PROCESSING DEVICE, IMAGE PROCESSING METHOD, AND DATA STRUCTURE OF 3D SCENE INFORMATION FOR DISPLAY”, which is hereby incorporated by reference in its entirety.

### TECHNICAL FIELD

This disclosure relates to an image processing device, an image processing method, and a data structure of 3D scene information for display for processing images of content reflecting user operations.

### BACKGROUND

Recent expansion of communication networks and development of image processing technologies have enabled users of various types of electronic content to enjoy the content regardless of viewing and listening environments. In the field of electronic games, for example, such a system is widespread which includes a server configured to collect information associated with respective situations of individual clients, such as details of user operations and position information, and distribute image data reflecting these as needed to allow a plurality of players to participate in the same game regardless of locations of the respective players.

Meanwhile, with recent development of machine learning technologies, such as deep learning, technologies for acquiring various types of information from images are also becoming familiar. For example, NeRF (Neural Radiance Fields) is known as a method for expressing 3D (three-dimensional) space by using a neural network. NeRF is a method for expressing volume density and radiance of an object in a 3D space as a fifth-dimensional function constituted by positional coordinates and directions with use of a neural network. For example, a state of an object viewed from an arbitrary viewpoint can be expressed by volume rendering if an expression of the object in NeRF is obtained on the basis of images of the object captured in a plurality of directions (for example, see Ben Mildenhall and five others, “NeRF: Representing Scenes as Neural Radiance Fields for View Synthesis,” Communications of the ACM, January 2022, Vol. 65, No. 1, pages. 99-106).

### SUMMARY

The image processing using machine learning as described above can form highly flexible images on the basis of limited information, but requires learning using appropriate and sufficient images. Accordingly, this type of image processing is applicable to only limited applicability ranges. For example, in a case of content which changes a display target scene in real time in accordance with a user operation, when to acquire training images and how to use learned information for the scene constantly changeable need to be determined. In this case, introduction of this image processing is not easily realizable. An increase in the flexibility of the viewpoints for the display world achieved by easy introduction of this image processing may cause a risk of exposure of the display world at an angle of view not originally intended.

The present disclosure has been developed in consideration of the above-mentioned problems. An object of the present disclosure is to provide a technology capable of appropriately controlling viewpoints during display based on three-dimensional information obtained by applying machine learning to content where situations of a display world are changeable in accordance with user operations.

For solving the above problems, an aspect of the present disclosure is directed to an image processing device. The image processing device includes an application execution unit that executes an application program, and generates, at a predetermined rate, a frame of a display image representing a three-dimensional display world where a situation changes in accordance with a user operation, and a system unit that causes the application execution unit to generate a training image different from the display image and representing the display world, performs a process for generating and using, for display, three-dimensional scene information indicating three-dimensional information of the display world by machine learning that uses the training image as supervised data, and limits a viewpoint set for the display world in the process on the basis of viewpoint restriction information associated with the application program.

Another aspect of the present disclosure is directed to an image processing device. The image processing device includes a three-dimensional scene information storage unit that stores three-dimensional scene information including a neural network that expresses three-dimensional information of a display world, and viewpoint restriction information associated with the three-dimensional scene information, the three-dimensional scene information and the viewpoint restriction information being associated with each other in the three-dimensional scene information storage unit, and an arbitrary viewpoint image generation unit that reads the three-dimensional scene information and the viewpoint restriction information from the three-dimensional scene information storage unit, and generates, by volume rendering using the three-dimensional scene information, a display image representing a view of the display world as viewed from an arbitrary viewpoint within a restriction range indicated by the viewpoint restriction information.

Further, another aspect of the present disclosure is directed to an image processing method. The image processing method includes, by an application execution unit, a step of executing an application program, and generating, at a predetermined rate, a frame of a display image representing a three-dimensional display world where a situation changes in accordance with a user operation, and by a system unit, a step of causing the application execution unit to generate a training image different from the display image and representing the display world, performing a process for generating and using, for display, three-dimensional scene information indicating three-dimensional information associated with the display world by machine learning that uses the training image as supervised data, and limiting a viewpoint set for the display world in the process on the basis of viewpoint restriction information associated with the application program.

Furthermore, another aspect of the present disclosure is directed to a data structure of three-dimensional scene information for display. The data structure of three-dimensional scene information for display associates data of three-dimensional scene information including a neural network that expresses three-dimensional information of a display world and, viewpoint restriction information read by an image processing device from a storage device together with the three-dimensional scene information and indicates restriction information imposed on an arbitrary viewpoint when a display image representing a view of the display world as viewed from the corresponding viewpoint is generated by volume rendering using the three-dimensional scene information.

Note that any combinations of the above constituent elements, and expressions of the present disclosure exchanged between methods, devices, systems, computer programs, data structures, recording media, and the like are also available as modes of the present disclosure.

According to the present disclosure, viewpoints are appropriately controllable during display based on three-dimensional information obtained by applying machine learning to content where situations of a display world are changeable in accordance with user operations.

### BRIEF DESCRIPTION OF DRAWINGS

FIG. 1 is a diagram illustrating a configuration example of an image display system to which the present embodiment is applicable.

FIG. 2 is a diagram illustrating an internal circuit configuration of a client terminal according to the present embodiment.

FIG. 3 is a diagram illustrating a basic flow of image processing according to the present embodiment in comparison with a conventional technology.

FIG. 4 is a diagram illustrating an overview of a processing flow performed in a mode for allowing a user to store a desired scene as 3D scene information.

FIG. 5 is a diagram illustrating a configuration of function blocks of the client terminal and a content server for achieving storage of scenes according to the present embodiment.

FIG. 6 is a diagram schematically illustrating a sequence of images generated in a main image output phase according to the present embodiment.

FIG. 7 is a diagram illustrating an arrangement of pseudo viewpoints generated by a pseudo viewpoint generation unit according to the present embodiment.

FIG. 8 is a diagram schematically illustrating a state of switching between main images and a standby image displayed on a display device according to the present embodiment.

FIG. 9 is a figure for explaining a mode where a 3D scene information generation unit extracts a region used for learning from a training image according to the present embodiment.

FIG. 10 is a diagram illustrating an overview of a processing flow performed in a mode for using 3D scene information for correction of display images.

FIG. 11 is a diagram for explaining reprojection in a correction example for correcting main images according to the present embodiment.

FIG. 12 is a diagram illustrating a configuration of function blocks of the client terminal and the content server for achieving correction of display images according to the present embodiment.

FIG. 13 is a diagram schematically illustrating a sequence of images generated according to the present embodiment.

FIG. 14 is a diagram for explaining a mode for generating images on the basis of shifted display viewpoints in a case of display of left-eye and right-eye images on a head-mounted display according to the present embodiment.

FIG. 15 is a diagram illustrating an overview of a processing flow performed in a mode for using 3D scene information for distribution of replay images.

FIG. 16 is a diagram illustrating a configuration of function blocks of the client terminal and the content server for achieving distribution of replay images according to the present embodiment.

FIG. 17 is a diagram schematically illustrating a sequence of images generated in a main image output phase according to the present embodiment.

FIG. 18 is a view illustrating an example of a screen displayed by an additional viewpoint setting unit of the content server to receive a setting of an additional viewpoint from a user according to the present embodiment.

FIG. 19 is a view illustrating an example of a heatmap crated by a heatmap creation unit of the content server according to the present embodiment.

FIG. 20 is a view illustrating an example of a display screen indicating a replay image and displayed on a display device in a replay image distribution phase according to the present embodiment.

FIG. 21 is a diagram illustrating a configuration of function blocks of the content server in a mode for limiting display viewpoints by an application.

FIG. 22 is a diagram illustrating an example of a data structure of 3D scene information according to the present embodiment.

### DETAILED DESCRIPTION

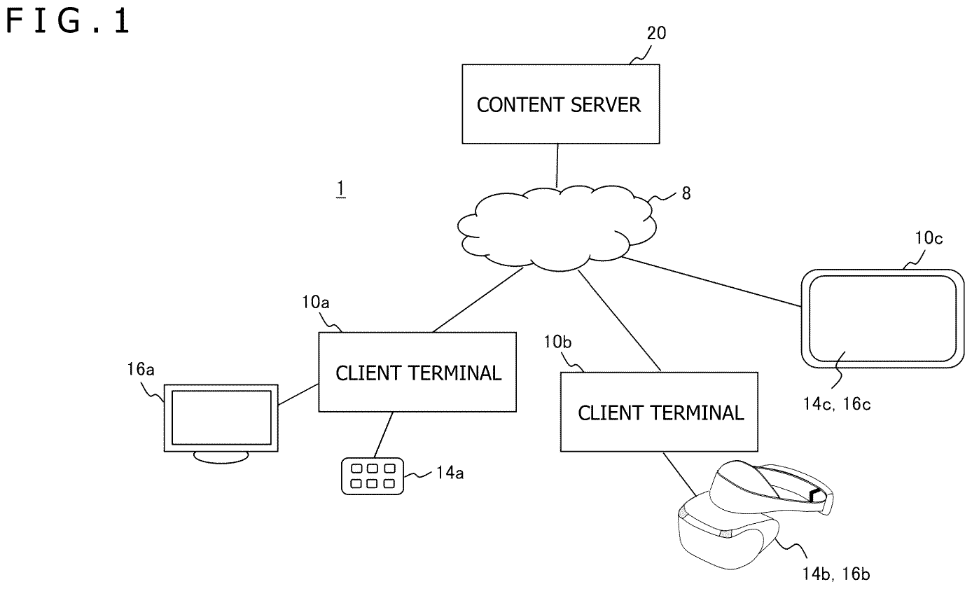

FIG. 1 illustrates a configuration example of an image display system to which the present embodiment is applicable. An image processing system 1 includes client terminals 10a, 10b, and 10c which display images in accordance with user operations or the like, and a content server 20 which provides image data used for display. Input devices 14a, 14b, and 14c operated to input user operations, and display devices 16a, 16b, and 16c for displaying images are connected to the corresponding client terminals 10a, 10b, and 10c, respectively. Communications between the client terminals 10a, 10b, and 10c and the content server 20 can be established via a network 8 such as a WAN (World Area Network) and a LAN (Local Area Network).

The client terminals 10a, 10b, and 10c may be connected to the display devices 16a, 16b, and 16c and the input device 14a, 14b, and 14c, respectively, either wirelessly or by wire. Alternatively, two or more of these devices may be integrally formed. For example, the client terminal 10b in the figure is connected to a head-mounted display constituting the display device 16b. A field of view of display images formed by the head-mounted display is variable according to movement of a user wearing the head-mounted display on the head. Accordingly, the head-mounted display also functions as the input device 14b.

Moreover, the client terminal 10c constitutes a portable terminal, a tablet terminal, or the like, and is formed integrally with the display device 16c, and the input device 14c which constitutes a touch pad covering a screen of the display device 16c. Accordingly, the external shapes and connection modes of the devices illustrated in the figure are not specifically limited to any shapes and modes. Similarly, the numbers of the client terminals 10a, 10b, and 10c and the content server 20 connected to the networks 8 are not specifically limited to any number. Hereinafter, the client terminals 10a, 10b, and 10c, the input devices 14a, 14b, and 14c, and the display devices 16a, 16b, and 16c will be collectively referred to as client terminals 10, input devices 14, and display devices 16, respectively.

Each of the input devices 14 is an ordinary input device, such as a controller, a keyboard, a mouse, a touch pad, and a joystick, and is configured to receive user operations and supply these to the corresponding client terminal 10. In addition, each of the input devices 14 may be any of various types of sensors, such as a motion sensor and a camera equipped on a head-mounted display, a portable terminal, a tablet terminal, or the like, and may supply sensor data received from these to the corresponding client terminal 10. Each of the display devices 16 may be an ordinary display, such as a liquid crystal display, a plasma display, an organic EL (Electroluminescence) display, a wearable display, and a projector, and is configured to display images output from the corresponding client terminal 10.

The content server 20 provides data of content including image display to the client terminals 10. The type of this content is not specifically limited to any number, and may be any one of an electronic game, an appreciation image, a promotion image, a web page, a video chat using an avatar, and the like. The content server 20 according to the present embodiment basically generates moving images and audio data indicating content, and immediately transmits these pieces of data to the client terminals 10 to realize streaming.

At this time, the content server 20 may sequentially acquire from the client terminals 10 information associated with user operations input to the input devices 14, or sensor data acquired by various types of sensors, and reflect these information and data in images and sounds. In this manner, a plurality of users are allowed to participate in the same game, and communicate with each other in a virtual world. However, the configuration of the image processing system is not limited to the configuration illustrated in the figure. For example, the main part generating images is not limited to the content server 20, and may be the client terminals 10 themselves, or both the content server 20 and the client terminals 10 in cooperation with each other.

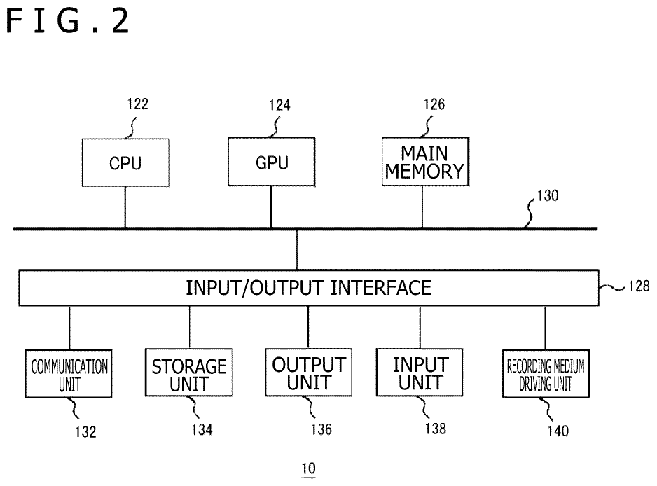

FIG. 2 illustrates an internal circuit configuration of each of the client terminals 10. The client terminal 10 includes a CPU (Central Processing Unit) 122, a GPU (Graphics Processing Unit) 124, and a main memory 126. These parts are connected to one another via a bus 130. An input/output interface 128 is further connected to the bus 130. The input/output interface 128 is an interface to which a communication unit 132 including a peripheral interface such as a USB (Universal Serial Bus), or a network interface of a wired or wireless LAN, a storage unit 134 such as a hard disk drive and a non-volatile memory, an output unit 136 outputting data to the display device 16, an input unit 138 to which data is input from the input device 14, and a recording medium driving unit 140 for driving a removable recording medium, such as a magnetic disk, an optical disk, and a semiconductor memory, are connected.

The CPU 122 implements an operating system stored in the storage unit 134 to control the whole of the client terminal 10. The CPU 122 also executes various programs read from the removable recording medium and loaded to the main memory 126, or downloaded via the communication unit 132. The GPU 124 has a geometry engine function and a rendering processor function, and is configured to perform a drawing process in accordance with a drawing command issued from the CPU 122, and store display images in an unillustrated frame buffer. Thereafter, the GPU 124 converts the display images stored in the frame buffer into video signals, and outputs the video signals to the output unit 136. The main memory 126 includes a RAM (Random Access Memory), and stores programs and data necessary for processing. The content server 20 may have a similar internal circuit configuration.

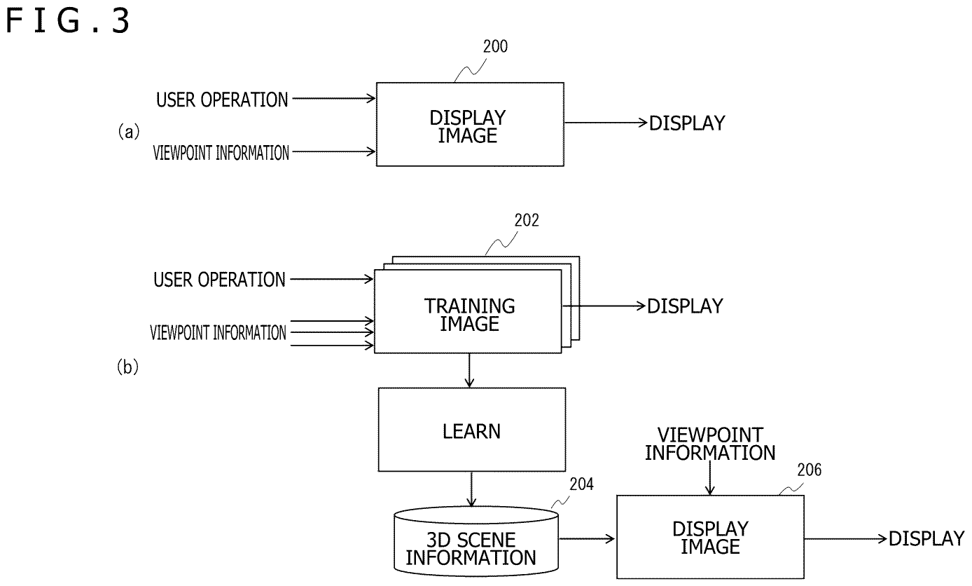

FIG. 3 illustrates a basic flow of image processing according to the present embodiment in comparison with a conventional technology. Note that the main process may be performed by either one of the content server 20 and the client terminal 10, or both in cooperation with each other as described above. Accordingly, this process will be discussed as a process performed by an “image processing device” without distinction between the content server 20 and the client terminal 10. It is assumed in the present embodiment that a display target is a world in a 3D space where various objects are present. The situation of this world is changeable in accordance with regulations of programs or the like, or user operations.

In a case of an ordinary process illustrated in (a), the image processing device initially acquires details of a user operation and information associated with a viewpoint position relative to a display world and a visual line direction as needed. Hereinafter, the whole of a 3D space of a display target will be referred to as a “display world,” while a view of the display world inside or near a display field of view will be referred to as a “scene.” Moreover, a viewpoint position and a visual line direction for a scene will be simply and collectively referred to as a “viewpoint” in some cases. The viewpoint may be manually operated by a user with use of the input device 14, or may be derived from movement of the user head with use of a motion sensor equipped on a head-mounted display, for example.

The image processing device draws a display image 200 in a field of view corresponding to viewpoint information while changing a scene in accordance with a user operation. For example, the image processing device forms the display image 200 by using a known computer graphics drawing technology, such as ray tracing and rasterization, and outputs the display image 200 to the display device 16. Continuous generation of the display image 200 by the image processing device at a predetermined frame rate enables display of a moving image representing a change of a scene in accordance with a user operation or the like. Specifically, the display image 200 is a frame of a moving image interactively changeable on the basis of a user operation or viewpoint information.

Hereafter, a moving image generated concurrently with acquisition of a user operation or viewpoint information will be referred to as a “main image.” A game image during play is a typical example of a main image. The image processing device may acquire details of user operations from a plurality of users in parallel as those in a multiplayer game, and reflect the acquired details in the display image 200. In a case of the present embodiment indicated in (b), the image processing device also generates a main image in a similar manner. According to the present embodiment, however, the image processing device designates a main image as a training image 202, and uses the training image 202 as supervised data for machine learning. The image processing device collects the training images 202 and performs machine learning to generate 3D scene information 204 indicating 3D information associated with a scene.

For applying NeRF to machine learning, data indicating 3D information associated with scenes is initially obtained by regression using multilayer perceptron (MVLP) on the basis of respective viewpoint information defined during generation of the training images 202, i.e., virtual viewpoint positions and visual line directions as input, and the corresponding training images 202 as supervised data. This data constitutes a neural network to which fifth-dimensional parameters each constituted by position coordinates (x, y, z) and a direction vector d(θ, φ) in a 3D space are input, and from which volume density a and three primary color information c (RGB) are output.

According to the present embodiment, data constituting this neural network will be referred to as “3D scene information.” However, any technologies capable of estimating 3D information on the basis of a plurality of two-dimensional images may be applied in place of NeRF. In addition, the expression format of 3D scene information is not specifically limited to any format. According to the present embodiment, the training image 202 is a main image. Accordingly, the details indicated by the training image 202, and also the 3D scene information 204 are constantly changeable. Indicated in the figure is such a situation where the 3D scene information 204 associated with a scene at a certain time or a short time considered as a time is generated.

For obtaining the 3D scene information 204 which is sufficiently accurate, it is desirable that the image processing device collect the training image 202 of a scene within a time or a short time considered as a time from the largest possible number of viewpoints. Accordingly, the image processing device collects the training images 202 by the following method, for example.

(1) Viewpoints appropriate for learning are generated by the image processing device as well as viewpoints specifying a field of vision of images actually displayed, and images corresponding to the generated viewpoints are formed.
(2) Display images corresponding to various viewpoints and distributed to terminals of a plurality of users viewing the same scene are used.

Hereinafter, a viewpoint created by the image processing device itself in (a) will be referred to as a “pseudo viewpoint,” while a viewpoint specifying actual display will be referred to as a “display viewpoint.” The image processing device may implement only one of (1) and (2), or both. For example, viewpoints not created by (2) may be complemented by (1). In any of these cases, the training image 202 may include the display image 200 which is an ordinary image illustrated in (a) of the figure. Accordingly, the image processing device may output at least part of the training image 202 to the display device 16 as a display image.

Meanwhile, the image processing device may separately generate a display image 206 or correct the display image with reference to the 3D scene information 204. On the basis of the 3D scene information 204, a state of a scene viewed from an arbitrary viewpoint can be expressed with high quality under a relatively light workload. For applying NeRF, the image processing device obtains a pixel value C(r) of a display image in the following manner by volume rendering which generates a ray r passing through pixels of a view screen from a display viewpoint, and integrates colors in the corresponding direction.

$$C ( r ) = {\int }_{{t}_{n}}^{{t}_{f}} T ( t ) σ ( r ( t ) ) c ( r ( t ) , d ) dt$$

In this equation, tn and tf are a proximal position and a distal position of the ray r, respectively, while T(t) is cumulative transmittance in the direction of the ray. These factors are expressed in the following manner.

$$T ( t ) = exp ( - {\int }_{{t}_{n}}^{t} σ ( r ( s ) ) ds )$$

Note that various improving methods have been proposed for NeRF, as well as the basic method disclosed in NPL 1, for example. Any of these methods may be applied to the present embodiment. Accordingly, details of NeRF are not further discussed herein. The image processing device may generate the single 3D scene information 204 indicating a scene within a time or a short time, or may continuously update the 3D scene information 204 at a predetermined rate by repeating the processing illustrated in the figure. In the former case, the image processing device can express a scene cut from a moment of a main image from an arbitrary viewpoint on the basis of the 3D scene information 204. In the latter case, a chronological order is also stored in a 3D scene information group. Accordingly, the image processing device can express a moving image, which includes a change equivalent to that of the main image, from the arbitrary viewpoint by forming the display image 206 on the basis of the used 3D scene information given the corresponding time.

For example, the image processing device achieves display on the basis of the 3D scene information 204 in response to a request from the user at timing different from the display period of main images, such as after an end of a game, and also receives a display viewpoint operation from the user. In this manner, for example, the image processing device can provide a function of viewing a scene of a moment stored by the user as the 3D scene information 204 during game play in various directions after an end of the play, or of sharing the scene with other users. Moreover, the image processing device can provide a function of distributing replay video allowed to be appreciated from arbitrary viewpoints.

In the case of the 3D scene information 204 continuously updated at a predetermined rate, the image processing device may use the 3D scene information 204 for correction at the time of display of main images. For example, in a mode for appreciating streamed images by using a head-mounted display, the image processing device corrects the images according to the position and the posture of the user head immediately before display on the basis of the 3D scene information 204. Examples of modes achievable by the present embodiment will be hereinafter described. Note that the respective modes will be individually discussed for easy understanding. However, a plurality of the modes may be combined and carried out in actual situations.

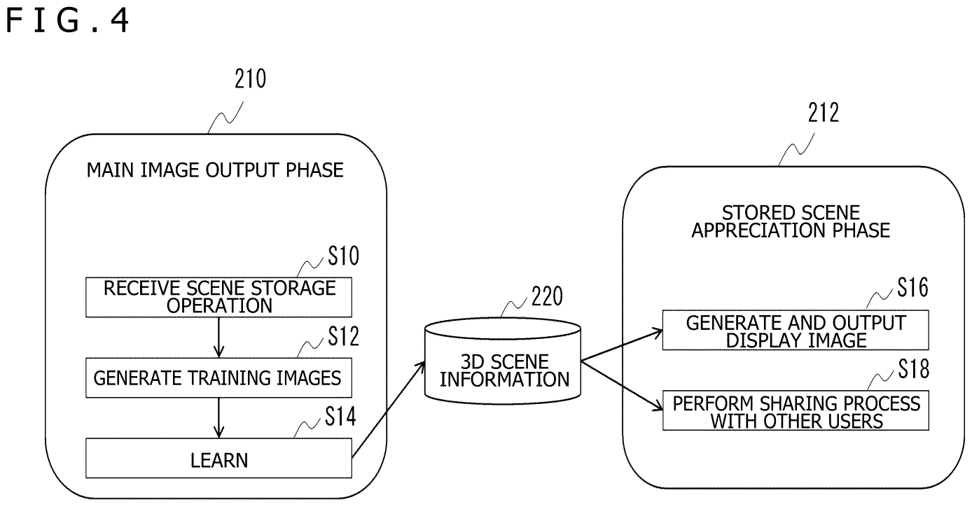

FIG. 4 illustrates an overview of a processing flow performed in a mode for allowing the user to store desired scenes as 3D scene information. The present mode is achieved in separate two periods of a main image output phase 210 and a stored scene appreciation phase 212. The main image output phase 210 is a period for outputting main images of content, such as during game play. In this period, the image processing device, such as the content server 20, receives a user operation for storing a scene (S10).

In response to this user operation, the content server 20 generates training images indicating the scene viewed from a plurality of viewpoints when the user operation is carried out (S12), and performs machine learning to generate 3D scene information 220 indicating this scene (S14). Note that generation of the training images and learning with use of these images may be concurrently achieved in actual situations. The stored scene appreciation phase 212 is started in response to a request of appreciation from the user at any timing, such as after an end of game play. In this period, the image processing device, such as the content server 20, generates an image of the scene with reference to the 3D scene information 220 stored beforehand, and outputs this image for display (S16).

Alternatively, the content server 20 performs a process for sharing the stored scene with other users according to a request from the user (S18). For example, by utilizing the mechanism of existing SNS (Social Networking Service), the content server 20 transmits the image of the scene to the client terminal 10 of a different user designated by the user desiring the sharing, and causes the client terminal 10 of the different user to display the image. In any of these cases, the content server 20 generates the display image of the scene on the basis of the 3D scene information 220 while changing the display viewpoint in accordance with a viewpoint operation performed by the user viewing the image.

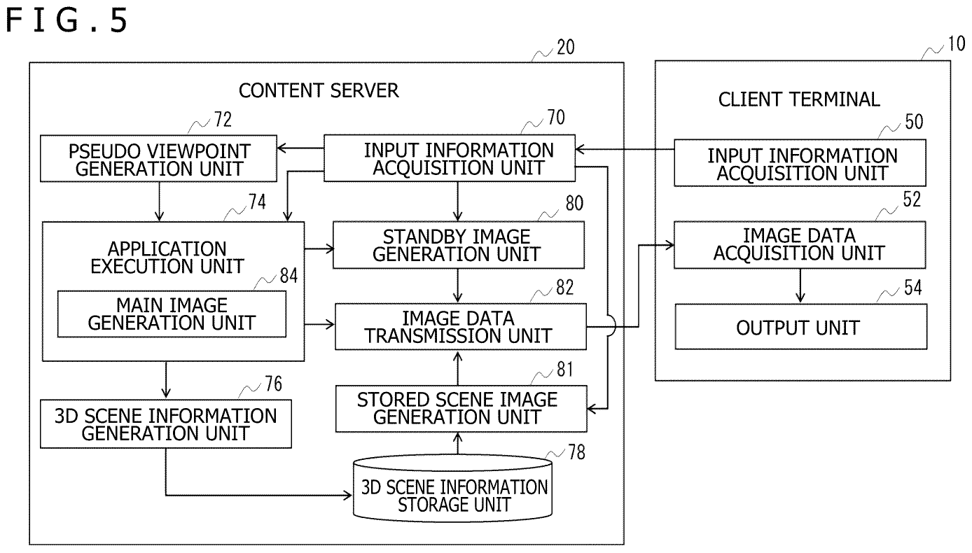

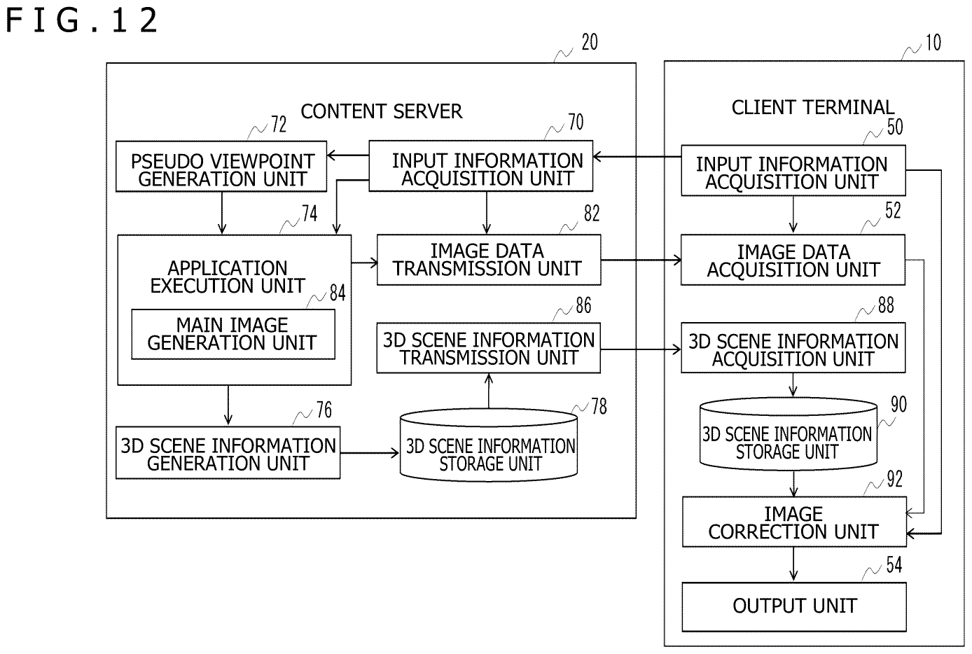

FIG. 5 illustrates a configuration of function blocks of the client terminal 10 and the content server 20 for achieving storage of the scene. The function blocks illustrated in this figure and FIGS. 12, 16, 21, and 23 referred to below can be implemented by configurations such as the CPU, the GPU, and the various memories illustrated in FIG. 2 in view of hardware, and can be implemented by programs for achieving functions such as a data input function, a data retention function, an image processing function, and a communication function loaded into a memory from a recording medium or the like in view of software. Accordingly, it should be understood by those skilled in the art that these function blocks can be implemented in various forms of only hardware, only software, or combinations of these, and therefore are not limited to any one of these forms. Moreover, while the role of main image processing is played by the content server 20 in the following explanation, at least part of this role may be achieved by the client terminal 10.

The client terminal 10 includes an input information acquisition unit 50 for acquiring input information such as user operations, an image data acquisition unit 52 for acquiring data of images from the content server 20, and an output unit 54 for outputting data of display images. The input information acquisition unit 50 acquires details of user operations from the input device 14 as needed. User operations include selection or starting of content, command input to content currently executed, and the like. The input information acquisition unit 50 further receives an operation for storing a desired scene from a main image of content, and an operation for requesting appreciation of a stored scene or sharing the scene with other users. The operation for storing a scene in the present embodiment requires only designation of timing of storage. Accordingly, it is preferable that this operation can be completed by an easy operation, such as a press of a button of the input device 14.

The input information acquisition unit 50 further acquires information associated with display viewpoints from the input device 14 or a head-mounted display as needed or at predetermined time intervals. Detection of the position and the posture of the head of the user wearing the head-mounted display, and acquisition of the information associated with the display viewpoints with reference to the detected position and posture are achieved by a known technology. This technology is applicable to the present embodiment. The display viewpoints herein include display viewpoints for main images, and also display viewpoints during appreciation of stored scenes. The input information acquisition unit 50 supplies the acquired information to the content server 20 as appropriate.

The image data acquisition unit 52 acquires data of display images from the content server 20. The data of the display images herein may include data of main images and data of images of stored scenes, and also data of standby images displayed in periods for learning scenes to be stored. The output unit 54 outputs the display images acquired by the image data acquisition unit 52 to the display device 16 and cause the display device 16 to display the display images.

The content server 20 includes an input information acquisition unit 70 which acquires input information from the client terminal 10, a pseudo viewpoint generation unit 72 which generates pseudo points for generating training images, an application execution unit 74 which executes an application such as an electronic game, a 3D scene information generation unit 76 which generates data of 3D scene information, a 3D scene information storage unit 78 which stores data of generated 3D scene information, a standby image generation unit 80 which generates standby images each indicating a training image generation period, a stored scene image generation unit 81 which generates images indicating stored scenes, and an image data transmission unit 82 which transmits data of display images to the client terminal 10.

The input information acquisition unit 70 acquires information associated with details of user operations and display viewpoints from the client terminal 10 as needed or at predetermined time intervals. The input information acquisition unit 70 basically supplies the acquired information to the application execution unit 74. At the time of acquisition of a user operation for storing a scene, the input information acquisition unit 70 also supplies the corresponding information and information associated with latest display viewpoints to the pseudo viewpoint generation unit 72. At this time, the pseudo viewpoint generation unit 72 generates pseudo viewpoints for generating training images on the basis of the latest display viewpoints. The pseudo viewpoint generation unit 72 supplies information associated with the generated pseudo viewpoints to the application execution unit 74.

The application execution unit 74 processes an application of content, such as an electronic game, on the basis of details of a user operation in the main image output phase. The application execution unit 74 includes a main image generation unit 84 to generate frames of main images corresponding to display viewpoints at a predetermined rate. Moreover, when a user operation for storing a scene is carried out, the main image generation unit 84 generates, as training images, images indicating states of scenes viewed from pseudo viewpoints generated by the pseudo viewpoint generation unit 72.

According to the example illustrated in the figure, it is assumed that the application execution unit 74 basically generates main images on the basis of viewpoint information supplied from the input information acquisition unit 70. In this case, the pseudo viewpoint generation unit 72 generates information associated with pseudo viewpoints in the same format as that of the viewpoint information supplied by the input information acquisition unit 70, and supplies the generated information to the application execution unit 74. In this manner, the application execution unit 74 can generate training images by usual processing without a necessity of distinction between true display viewpoints and pseudo viewpoints. Accordingly, the present embodiment is easily applicable to conventional content not compatible with machine learning.

However, the present embodiment is not limited to this example. An API (Application Programming Interface) having a function of generating pseudo viewpoints may be prepared and designated in an application program to allow the application execution unit 74 to include the pseudo viewpoint generation unit 72. In any of these cases, it is preferable that the application execution unit 74 temporarily stop progress of content until the main image generation unit 84 generates a sufficient number of training images. In this manner, highly accurate 3D scene information can be generated by generating a sufficient number of training images on an assumption that the scene generated at the time of the storage operation by the user is a still scene.

In the case of the temporary stop of progress of the content, the application execution unit 74 restarts progress of the contents at the time of completion of generation of all images corresponding to pseudo viewpoints. The 3D scene information generation unit 76 acquires training images generated by the application execution unit 74 in the main image output phase, and generates 3D scene information associated with scenes to be stored by the machine learning described above. Note that the 3D scene information generation unit 76 may extract only regions to be stored from training images generated by the main image generation unit 84, and use the extracted regions for machine learning.

The 3D scene information storage unit 78 stores 3D scene information generated by the 3D scene information generation unit 76. The 3D scene information storage unit 78 stores the 3D scene information in association with information such as identification information associated with the user requesting storage of a scene, and information associated with timing of storage relative to the time axis of main images. In this manner, search for a scene to be displayed in the stored scene appreciation phase is easily achievable. The standby image generation unit 80 generates a standby image displayed in a period for learning an image when a user operation for storing a scene is performed in the main image output phase. The user can recognize progress of storage of the scene on the basis of display of the standby image. Moreover, display of the standby image can reduce a risk of motion sickness caused when the field of view does not follow the motion of the head as a result of a temporary stop of the scene in a case where the display device 16 is a head-mounted display.

When a user operation for requesting appreciation of a stored scene is performed in the stored scene appreciation phase, the stored scene image generation unit 81 generates a display image representing this scene by the volume rendering described above on the basis of 3D scene information stored in the 3D scene information storage unit 78. At this time, the stored scene image generation unit 81 acquires a display viewpoint from the input information acquisition unit 70, and generates a display image according to the display viewpoint while changing the viewpoint for the stored scene. The image data transmission unit 82 sequentially transmits data of main images generated by the main image generation unit 84, and standby images generated by the standby images generation unit 80 to the client terminal 10 in the main image output phase.

The image data transmission unit 82 also transmits data of images of stored scenes generated by the stored scene image generation unit 81 to the client terminal 10 in the stored scene appreciation phase. In a case where a user operation for sharing a stored scene with other users is received, the image data transmission unit 82 transmits data of the image of the stored scene to the client terminals 10 sharing the scene. In this case, a platform of ordinary SNS can be used in actual situations. Accordingly, detailed function blocks for this purpose are not depicted in the figure.

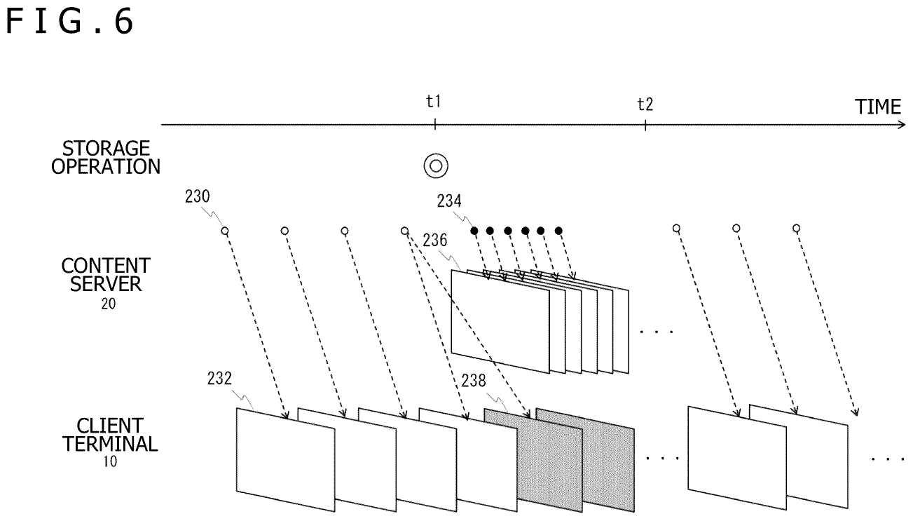

FIG. 6 schematically illustrates a sequence of images generated in the main image output phase in the present mode. This figure indicates a relation between viewpoints recognized or generated by the content server 20, and destinations of respective frames generated on the basis of these viewpoints on an assumption that the lateral direction corresponds to the time axis. The content server 20 basically generates frames (e.g., frame 232) of display images at a predetermined rate in correspondence with display viewpoints (e.g., display viewpoint 230) represented by white circles, and transmits the generated frames to the client terminal 10.

In this manner, the user is allowed to perform an operation for storing a scene desired to be stored by pressing a predetermined button provided on the input device 14, for example, at the time of an arrival of this scene in main images displayed on the client terminal 10. In response to this storing operation at a time t1 in the figure, the content server 20 generates pseudo viewpoints (e.g., pseudo viewpoint 234) represented by black circles, and generates training images (e.g., training image 236) in correspondence with the generated pseudo viewpoints. The content server 20 temporarily stops generation of the frames of the display images in the period for generating the training images. As illustrated in the figure, the rate for generating the training images may be made higher than the rate of the display frames according to the processing ability of the content server 20.

In a case where the drawing processing ability of the main image generation unit 84 is 120 fps, for example, the main image generation unit 84 sequentially processes 120 pseudo viewpoints prepared according to this processing ability. In this manner, 120 training images can be generated in one second. The content server 20 temporarily stops progress of content in the period for generating the training images, generates standby images (e.g., standby image 238) indicated with shading, and transmits the standby images to the client terminal 10. As described above, the standby images may be either still images or moving images. Moreover, the standby images may be generated by the client terminal 10. Display of the standby images continues until a time t2 which is the time when the content server 20 completes generation of a predetermined number of training images. The display time of the standby images may be a period of several seconds for an environment where 120 training images can be generated in one second as described above.

The content server 20 generates 3D scene information associated with scenes on the basis of the training images generated up to the time t2, and stores the generated 3D scene information in the 3D scene information storage unit 78. The content server 20 restarts progress of the content at the time t2, generates frames of display images at a predetermined rate in correspondence with the latest display viewpoints, and transmits the generated frames to the client terminal 10.

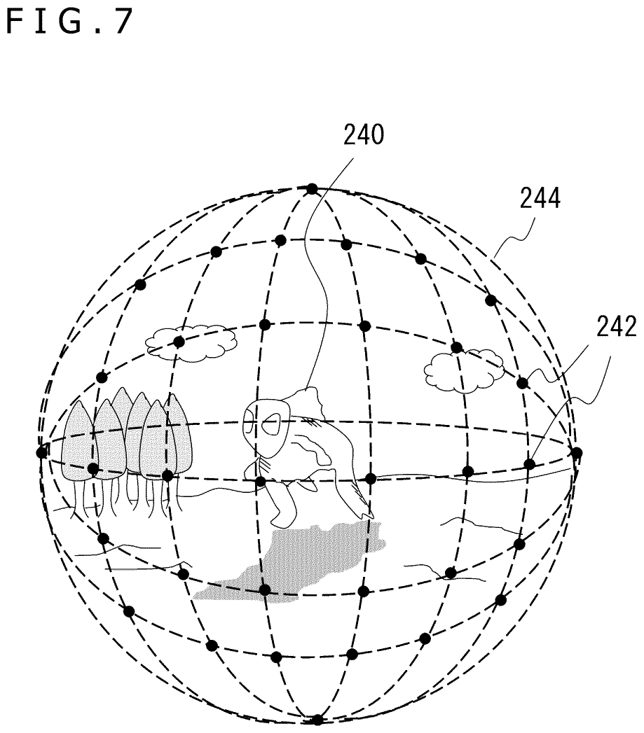

FIG. 7 illustrates an arrangement of pseudo viewpoints generated by the pseudo viewpoint generation unit 72. In this example, a plurality of pseudo viewpoints (e.g., viewpoints 242) are arranged in such a manner as to surround a scene of an object 240 and the like included in a display field of view at the time when an operation for storing the scene is performed. For example, the pseudo viewpoint generation unit 72 equally arranges the pseudo viewpoints at predetermined intervals on a plane of a sphere 244 having a predetermined radius and formed with the center located at a position within the scene and corresponding to the center of the display field of view. In addition, visual lines extending from the respective pseudo viewpoints toward the center of the sphere 244 are set.

This arrangement can generate training images indicating the scene viewed by the user when the storing operation is performed, and expressed in various directions. However, the arrangement of the pseudo viewpoints is not limited to the arrangement illustrated in the figure. For example, in a case where the scene includes the ground, a hemisphere may be adopted instead of the sphere 244 to validate only the area above the ground. In addition, the plane where the viewpoints are to be arranged is not limited to a spherical surface, and may be a surface of any shape such as a cuboid, a cylinder, and an ellipsoid, or may be other than a surface of a specific 3D shape depending on cases. Moreover, the viewpoints are not required to be equally arranged, and may be distributed in an imbalanced manner, such as a case where more viewpoints are arranged in a range where display viewpoints are highly likely to be located in the stored scene appreciation phase, and a range where an important object is viewed. This arrangement can efficiently generate accurate 3D scene information for an important region contained in the scene.

Furthermore, the pseudo viewpoint generation unit 72 may set pseudo viewpoints on surfaces of a plurality of 3D shapes. For example, the pseudo viewpoint generation unit 72 may arrange pseudo viewpoints on each of surfaces of concentric spheres having different sizes. This arrangement can generate training images indicating the scene viewed at various distances. In addition, the directions of the visual lines are not limited to directions toward the center of the scene. For example, the pseudo viewpoint generation unit 72 may radially set visual lines from a starting point located at a position of a virtual user in the scene.

In this manner, 3D scene information to be generated is applicable to large rotation of the display field of view in the stored scene appreciation phase. In any of these cases, the accuracy of the 3D scene information to be obtained improves as the number of the pseudo viewpoints increases. Accordingly, the quality of the display images improves. In this case, however, the time required for generation of the training images, and the consumption of memories increase. Accordingly, it is preferable that the number of the pseudo viewpoints generated by the pseudo viewpoint generation unit 72 be determined according to the processing ability of the content server 20, the details of the scene, the purpose of generation of the 3D scene information, and the like.

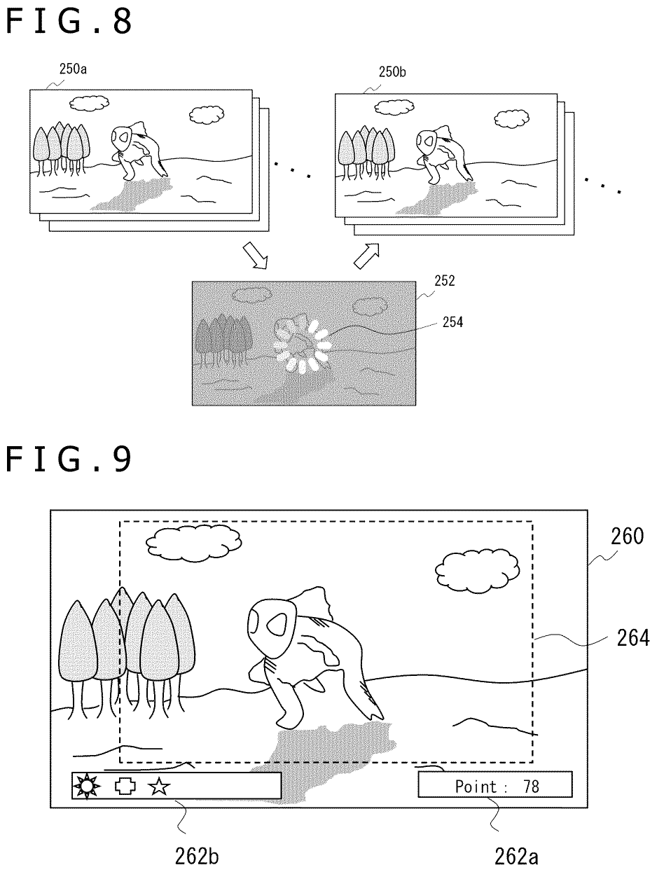

FIG. 8 schematically illustrates a state of switching between main images and a standby image displayed on the display device 16 according to the present embodiment. As described above, during progress of main content, such as during game play, frames 250a of main images are displayed on the display device 16 at a predetermined rate. Meanwhile, when the user performs an operation for storing a scene at any timing, the display is switched to a standby image 252. According to the example in the figure, a progress indicator 254 representing a state of processing is superimposed and displayed while lowering chroma or brightness of the frame 250a of the main image displayed during the storing operation.

However, the configuration of the standby image is not limited to the configuration illustrated in the figure, and may be a simple solid image, or an image not containing an image of the frame 250a. Alternatively, any processing may be applied to the image of the frame 250a itself. When generation of the training images is completed, display is restarted from frames 250b of the main images immediately after the completion.

FIG. 9 is a figure for explaining a mode where the 3D scene information generation unit 76 extracts a region used for learning from a training image according to the present embodiment. In this example, a main image 260 generated by the main image generation unit 84 of the application execution unit 74 includes, as well as an image of a scene, additional images necessary for content, such as a column 262a indicating a score of a game, and a column 262b indicating icons of carried weapons, each superimposed and displayed. In a case where the main image generation unit 84 generates images without distinction between display viewpoints and pseudo viewpoints, training images similarly configured may be formed. Accordingly, the 3D scene information generation unit 76 excludes regions where these additional images are displayed, and uses only regions where the scene itself is displayed for machine learning.

This manner of extraction can eliminate problems such as generation of 3D scene information including extra information, and generation of a false object. The size and the position of a region 264 can be set beforehand according to the sizes and the positions of the superimposed additional images. However, the region 264 is set not only on the basis of the presence of the additional images, but also in consideration of appropriateness as a scene appreciated later, or for other reasons. For example, the region to be extracted may be widened or narrowed according to a range of an image of a main object occupying a main image currently displayed. Specifically, the region to be extracted may be fixed, or may be varied according to a change of display details.

According to the mode for storing a scene desired by the user as described above, the content server 20 generates 3D scene information associated with a scene at certain timing by machine learning in accordance with a user operation for storing this scene in a main image currently displayed. In this manner, the user is allowed to appreciate the scene at a moment appearing in progress of content from an arbitrary viewpoint on a different occasion. Moreover, a stored scene can be shared with other users such as friends. Appreciation of the stored scene from an arbitrary viewpoint in this manner enables reviewing or verification of the stored situation with reality not achievable by the conventional technology such as screenshot of an image.

For storing a scene, a large number of pseudo viewpoints are generated according to a display status at that time, and training images are intensively generated. In this manner, images appropriate for learning can be efficiently generated by an easy operation even for a user lacking technical knowledges, and highly accurate 3D scene information can be generated in a short time. Moreover, pseudo viewpoint information is generated in the same format as that of ordinary application processing, and supplied to the application side to generate training images. Accordingly, conventional applications not compatible with machine learning are easily applicable.

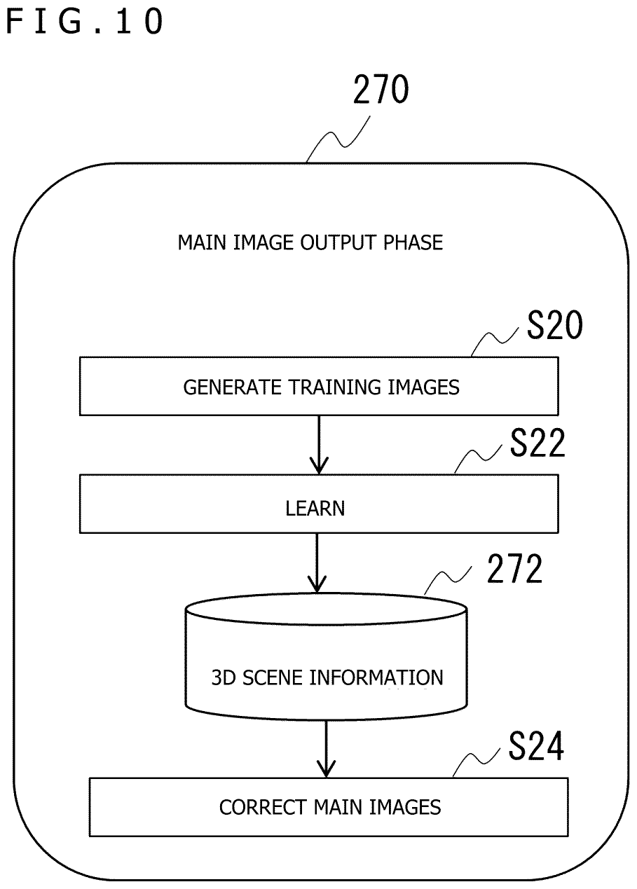

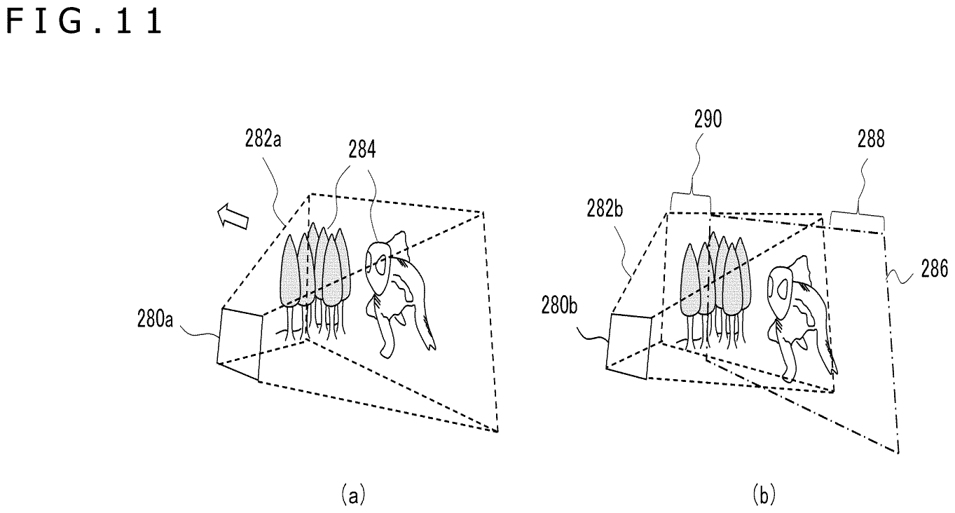

FIG. 10 illustrates an overview of a processing flow performed in a mode for using 3D scene information for correction of display images. The present mode is achieved in the main image output phase 270 for outputting main images of content, such as during game play. In this period, the image processing device, such as the content server 20, generates training images as well as main images to be displayed (S20), and performs machine learning to generate 3D scene information 272 indicating scenes for each time step (S22). In other words, the 3D scene information 272 is updated with an elapse of time. Thereafter, the image processing device, such as the client terminal 10, corrects the main images to be displayed on the basis of the latest 3D scene information 272 (S24). Highly accurate correction can be achieved by correcting images constituted by two-dimensional information with reference to 3D scene information including 3D information. In this manner, quality of the display images can be raised.

FIG. 11 is a diagram for explaining reprojection in a correction example of a main image. Reprojection refers to a process for correcting main images once generated such that the main image has a field of view aligned with the position and the posture of the user head immediately before display when the display device 16 is a head-mounted display or the like. For displaying the main images generated by the content server 20 on the client terminal 10, a certain time is required from recognition of display viewpoints by the content server 20 until display of frames generated according to these display viewpoints on the client terminal 10 as illustrated in FIG. 6. A further time is required to transmit the display viewpoints from the client terminal 10 to the content server 20 in actual situations.

Accordingly, delays are produced in changes of the fields of view of the displayed main images from actual changes of the viewpoints, and therefore unignorable incongruity may be caused. Particularly in the case where the display device 16 is a head-mounted display, a sense of immersion in virtual reality may be deteriorated, or motion sickness may be caused. In this case, quality of user experiences may be lowered. Accordingly, the client terminal 10 corrects each of the frames of the main images transmitted from the content server 20 to a frame corresponding to the field of view immediately before display.

In the figure, (a) illustrates a state of the content server 20 generating a main image. The content server 20 sets a view screen 280a in correspondence with the display viewpoint recognized at that time, and draws on the view screen 280a an image 284 contained in a frustum 282a and corresponding to the view screen 280a. Suppose herein that the viewpoint during display is shifted to the left as indicated by an arrow. In this case, the client terminal 10 corrects the image to such an image which has a field of view corresponding to a view screen 280b shifted to the left as indicated in (b).

A frustum 282b corresponding to the view screen 280b newly set does not include a region 288 in a field of view 286 of the transmitted main image but includes a region 290 as a new region. Accordingly, the client terminal 10 deletes the image in the region 288, additionally draws an image in the region 290 newly required, and designates the drawn image as a display image after correction. At this time, the client terminal 10 additionally draws an image on the basis of the latest 3D scene information generated by the content server 20. In this manner, a high-quality image can be generated considering a change of a color tone produced by a shift of the viewpoint, for example.

FIG. 12 illustrates a configuration of function blocks of the client terminal 10 and the content server 20 for achieving correction of display images. Note that blocks having functions similar to the corresponding functions of the function blocks illustrated in FIG. 6 are given the same reference signs, and the same explanation is not repeated where appropriate. The client terminal 10 includes the input information acquisition unit 50 for acquiring input information such as user operations, the image data acquisition unit 52 for acquiring data of images from the content server 20, a 3D scene information data acquisition unit 88 for acquiring data of 3D scene information from the content server 20, a 3D scene information storage unit 90 for storing data of 3D scene information, an image correction unit 92 for correcting display images on the basis of 3D scene information, and the output unit 54 for outputting data of display images.

The input information acquisition unit 50 acquires information associated with details of user operations and display viewpoints as described above, and supplies the acquired information to the content server 20 and the image correction unit 92 as appropriate. The image data acquisition unit 52 acquires data of respective frames of main images from the content server 20. The 3D scene information data acquisition unit 88 sequentially acquires data of 3D scene information continuously generated in predetermined time steps from the content server 20. The 3D scene information storage unit 90 stores data of 3D scene information acquired by the 3D scene information data acquisition unit 88.

The image correction unit 92 corrects main images transmitted from the content server 20 on the basis of data of 3D information stored in the 3D scene information storage unit 58. Specifically, as described above, the latest display viewpoint is acquired from the input information acquisition unit 50, and an insufficient region of a field of view corresponding to the latest display viewpoint is additionally drawn with reference to the 3D scene information. Accordingly, the content server 20 transmits the data of the main image with a time stamp added to the data, while the image correction unit 92 acquires a change amount of the display viewpoint on the basis of a time difference between the time stamp and the correction time, and specifies a shortage of the display image.

Thereafter, the image correction unit 92 draws a region of this shortage on the basis of the latest 3D screen information. Moreover, the image correction unit 92 excludes a region out of the field of view from the frames of the main images transmitted from the content server 20, and then connects the frames with the region drawn by the image correction unit 92 to generate display images. However, correction performed by the image correction unit 92 is not limited to addition or deletion of the field of view. For example, the image correction unit 92 may redraw an object located at a short distance and easily influenced by a change of the viewpoint, and a region near this object on the basis of the 3D scene information. In this manner, such images which have tones adjusted in correspondence with changes of viewpoints can be displayed. Alternatively, the image correction unit 92 may draw the whole display images with reference to the 3D scene information.

If 3D scene information corresponding to transitions of scenes is prepared by machine learning and provided for the client terminal 10, the client terminal 10 can generate high-quality images on the basis of this information by a lighter workload than that of ordinary processing such as ray tracing. On an assumption that display images can be finally generated by the client terminal 10 on the basis of 3D scene information by utilizing this theory, the content server 20 can eliminate a necessity of generating main images exactly aligned with display viewpoints. Accordingly, the content server 20 may generate main images corresponding to viewpoints deliberately shifted from the display viewpoints to raise efficiency of training image collection.

For example, in a case where the display device 16 is a head-mounted display, the image correction unit 92 may draw main images with reference to 3D scene information for at least either the right eye or the left eye on the basis of the latest display viewpoints. In this manner, such a restricting condition that a pair of highly redundant main images need to be constantly generated for the left eye and the right eye need not be imposed on the content server 20. For example, the content server 20 generates a pair of main images with reduced overlaps of the field of view, and with wider intervals set between the left and right viewpoints than in actual situations. In this manner, various training images can be collected in a short time. The output unit 54 outputs display images corrected or generated by the image correction unit 92 to the display device 16, and causes the display device 16 to display the display images.

The content server 20 includes the input information acquisition unit 70 which acquires input information from the client terminal 10, the pseudo viewpoint generation unit 72 which generates pseudo points for generating training images, the application execution unit 74 which executes an application such as an electronic game, the 3D scene information generation unit 76 which generates data of 3D scene information, the 3D scene information storage unit 78 which stores data of generated 3D scene information, the image data transmission unit 82 which transmits data of main images to the client terminal 10, and a 3D scene information data transmission unit 86 which transmits data of 3D scene information to the client terminal 10.

The input information acquisition unit 70 acquires information associated with details of user operations and display viewpoints from the client terminal 10 as needed or at predetermined time intervals, and supplies the acquired information to the application execution unit 74. The input information acquisition unit 70 further supplies information associated with display viewpoints to the pseudo viewpoint generation unit 72. The pseudo viewpoint generation unit 72 generates pseudo viewpoints for generating training images on the basis of the latest display viewpoints. According to the present mode, 3D scene information associated with scenes is learned while displaying main images. In this case, training images are formed at only limited opportunities.

Accordingly, the input information acquisition unit 70 may supply the information associated with the display viewpoint and acquired at that time to only the pseudo viewpoint generation unit 72, and the pseudo viewpoint generation unit 72 may supply this information to the application execution unit 74 after deliberately shifting the display viewpoint or adding a pseudo viewpoint. The pseudo viewpoint generation unit 72 may predict later display viewpoints according to a history of changes of the display viewpoints up to the current time, and generate pseudo viewpoints with a distribution corresponding to the predicted display viewpoints.

The application execution unit 74 processes an application of content on the basis of details of user operations. The application execution unit 74 includes the main image generation unit 84 to generate frames of main images corresponding to display viewpoints at a predetermined rate. However, as described above, the main image generation unit 84 may generate images corresponding to pseudo viewpoints shifted from the display viewpoints as frames of main images to be displayed. Moreover, the main image generation unit 84 generates, as training images, images indicating scenes as viewed from the pseudo viewpoints generated by the pseudo viewpoint generation unit 72.

The pseudo viewpoint generation unit 72 in this mode also generates information indicating pseudo viewpoints in the same format as that of viewpoint information supplied by the input information acquisition unit 70, and supplies the generated information to the application execution unit 74. In this manner, the application execution unit 74 can generate training images by usual processing without a necessity of distinction between true display viewpoints and pseudo viewpoints. Accordingly, the present embodiment is easily applicable to conventional content not compatible with machine learning. However, as described above, the function of the pseudo viewpoint generation unit 72 may be allocated to the application execution unit 74 by using an API or the like.

The 3D scene information generation unit 76 acquires training images containing main images to be displayed from the application execution unit 74, and generates 3D scene information associated with scenes for each predetermined time step by the machine learning described above. In this case, the 3D scene information generation unit 76 may similarly extract only regions necessary for correction of display images from images generated by the main image generation unit 84, and use the extracted regions for machine learning. The 3D scene information storage unit 78 temporarily stores 3D scene information generated by the 3D scene information generation unit 76. The image data transmission unit 82 transmits data of main images generated by the main image generation unit 84 to the client terminal 10 at a predetermined rate. The 3D scene information data transmission unit 86 transmits data of 3D scene information stored in the 3D scene information storage unit 78 to the client terminal 10 at a predetermined rate.

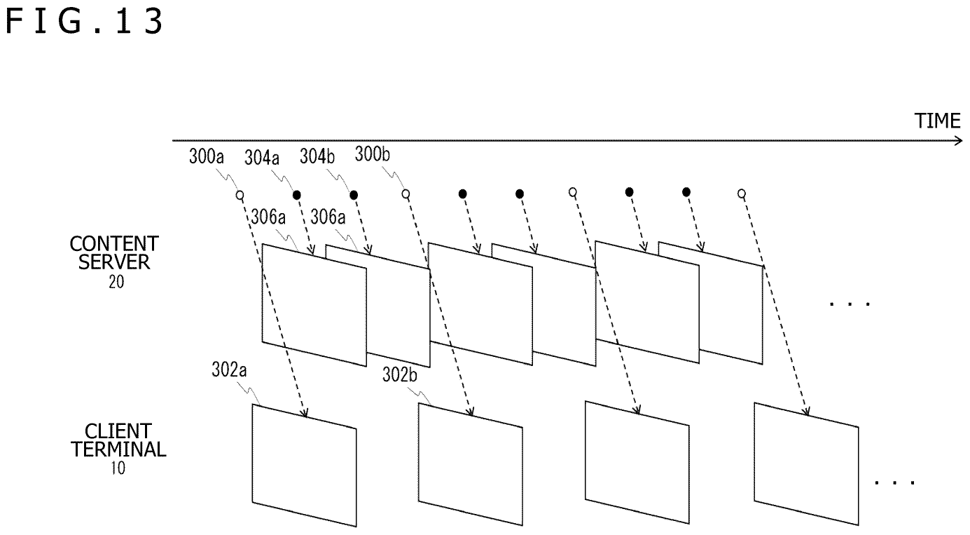

FIG. 13 schematically illustrates a sequence of images generated in the present embodiment. This figure indicates a relation between viewpoints recognized or generated by the content server 20, and destinations of respective frames generated according to these viewpoints on an assumption that the lateral direction corresponds to the time axis. Similarly to FIG. 6, the content server 20 basically generates frames (e.g., frames 302a and 302b) of display images at a predetermined rate in correspondence with display viewpoints (e.g., display viewpoints 300a and 300b) represented by white circles, and transmits the generated frames to the client terminal 10. However, as described above, the display viewpoints in this case may be substantial pseudo viewpoints shifted from the actual display viewpoints. The client terminal 10 appropriately corrects the transmitted images and displays the corrected images.

Moreover, the content server 20 generates training images between generated frames of display images, i.e., in cycles before generation of subsequent frames. For example, the content server 20 generates pseudo viewpoints 304a and 304b represented by black circles, and training images 306a and 306b corresponding to these pseudo viewpoints in a process performed between the processes of the display viewpoints 300a and 300b. The content server 20 also uses frames of display images transmitted to the client terminal 10 as training images. As illustrated in the figure, training images necessary for generating 3D scene information can be efficiently acquired by drawing these images at a rate higher than the frame rate for display.

For example, in a case where the frame rate for display is 60 fps, the twice larger number of training images than the number of the frames of the display images can be acquired when the main image generation unit 84 operates at 120 fps. In addition, the three times larger number of training images than the number of the frames of the display images can be acquired when the main image generation unit 84 operates at 180 fps. According to the example illustrated in the figure, the display images are transmitted to the one client terminal 10. However, if images corresponding to different display viewpoints are transmitted to the client terminal 10 of a different user, as in a multiplayer game, these images can also be used as training images. Efficient collection of training images in this manner can raise accuracy of 3D scene information indicating scenes in each time step, and also achieve display of high-quality images.

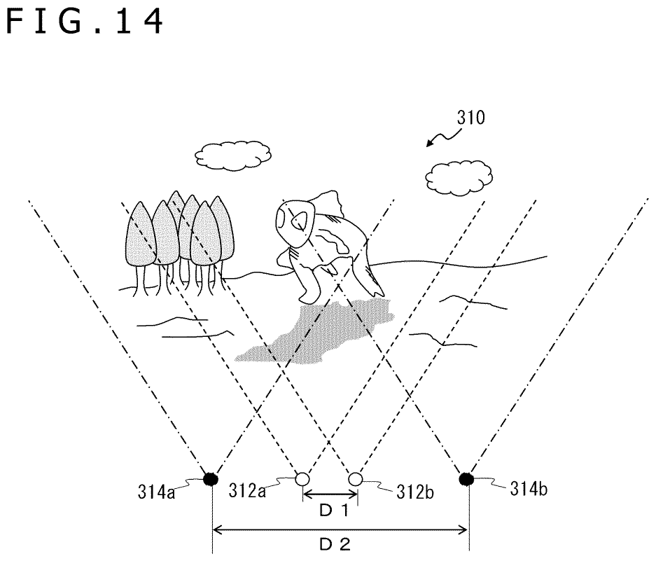

FIG. 14 is a diagram for explaining a mode for generating images on the basis of shifted display viewpoints in a case of display of left-eye and right-eye images on a head-mounted display. This figure schematically illustrates display viewpoints for a scene 310. In a case where the head-mounted display is designated as a display destination, a pair of display viewpoints 312a and 312b are set with a distance D1 left therebetween, which has a length equivalent to an actual interval between both eyes, and images for both viewpoints are generated in fields of view indicated by broken lines. The pair of images are displayed on the head-mounted display at positions corresponding to the left and right eyes of the user. In this manner, the scene 310 can be displayed as a 3D scene.

The distance D1 between the display viewpoints 312a and 312b set at this time is generally called an inter pupillary distance an IPD, and is approximately 60 mm in length for an adult, for example. However, the IPD differs for each person, and can be set as a variable parameter for a head-mounted display in many cases to achieve an appropriate 3D view. Generally, a pair of images are generated on the basis of a setting value of this IPD. Meanwhile, as illustrated in the figure, the ordinary display viewpoints 312a and 312b widely overlap with each other in the field of view for the scene 310. In this case, for the purpose of use as training images, the pair of images generated under this setting are considered to be redundant and inefficient. Accordingly, the pseudo viewpoint generation unit 72 considerably increases the setting value of IPD, such as 1 m.

In the example illustrated in the figure, the value of the IPD is set to D2 (>D1). In this case, the interval between display viewpoints 314a and 314b has a larger distance than that of the original display viewpoints 312a and 312b. When images are generated according to this setting, information associated with the scene 310 in a wider range can be obtained by processing frames at respective times as indicated by one-dotted chain lines. Accordingly, highly accurate 3D scene information can be generated in a short time. Note that the display viewpoints 314a and 314b set herein are different from the actual display viewpoints 312a and 312b. Accordingly, as described above, the image correction unit 92 of the client terminal 10 generates display images indicating scenes viewed from the actual display viewpoints 312a and 312b on the basis of 3D scene information. This mode is achievable only by changing the setting value of IPD. Accordingly, the application execution unit 74 is only required to perform ordinary processing, and therefore conventional content not compatible with machine learning is easily applicable similarly to above.

According to the mode for correcting display as described above, the content server 20 generates training images concurrently with generation of display images, and generates 3D scene information associated with scenes for each time step. The client terminal 10 sequentially acquires latest 3D scene information from the content server 20, and corrects or draws display images on the basis of this information. In this manner, images to be displayed can accurately express changes of tones or the like according to changes of viewpoints, and simultaneously follow movement of viewpoints, as images not obtainable only on the basis of transmitted images. Moreover, the client terminal 10 is allowed to generate display images with a light workload. Accordingly, the content server 20 can more efficiently collect training images with higher flexibility of viewpoints for generating images.

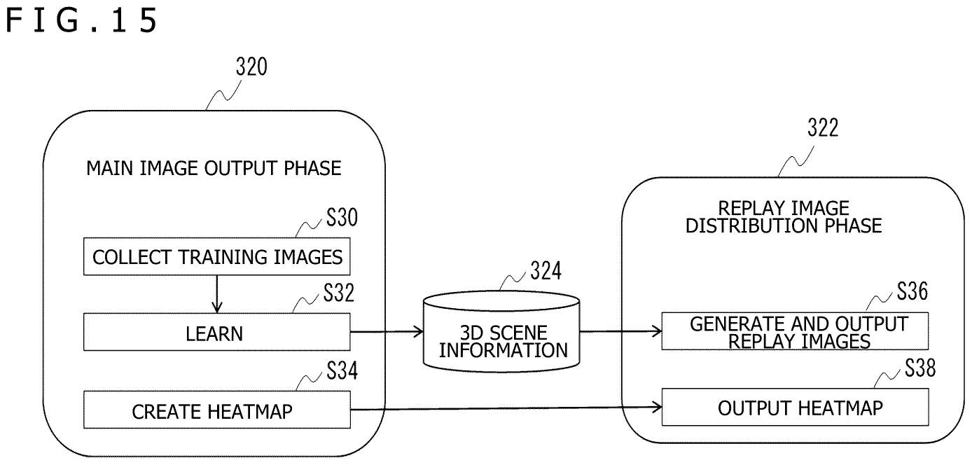

FIG. 15 illustrates an overview of a processing flow performed in a mode for using 3D scene information for distributing replay images. The present mode is achieved in separate two periods of a main image output phase 320 and a replay image distribution phase 322. In the main image output phase 320 for outputting main images of content, such as during game play, the image processing device, such as the content server 20, collects training images (S30), and performs machine learning to generate 3D scene information 324 indicating scenes for each time step (S32).

Note that the training images collected in S30 may be drawn on the basis of pseudo viewpoints generated by the image processing device itself, as discussed above. Meanwhile, in such a mode where the content server 20 receives a plurality of display viewpoints and concurrently generates main images and distributes the main images to the respective client terminals 10, such as during a multiplayer game, these display images may be designated as the training images. This mode will be hereinafter chiefly discussed. However, the content server 20 may additionally set viewpoints to increase training images also in this case.

The replay image distribution phase 322 is started in response to a request for distribution from the user at any timing, such as after an end of game play. Note that the user requesting distribution of replay images is not limited to the user having performed operations in the main image output phase 320, such as a game player. In the replay image distribution phase 322, the content server 20 generates replay images on the basis of 3D scene information 324 stored in advance, and outputs the replay images to the client terminal 10 having issued the distribution request (S36). The 3D scene information is updated for each time step, and time is input to generate images. In this manner, the generated images can be displayed as moving images. Moreover, replay images can be displayed in various positions and directions in accordance with user operations for varying the viewpoints.

Note that more imbalance of the display viewpoints is produced in the main image output phase 320 as the display world becomes wider in this mode. Accordingly, the highly accurate 3D scene information 324 can be generated for a place having high density of display viewpoints, while the accuracy of the 3D scene information 324 lowers for a low-density place. Meanwhile, the 3D scene information 324 cannot be generated for a place containing no display viewpoint, and therefore no replay image can be displayed at that place. The content server 20 therefore creates a heatmap indicating levels of density of display viewpoints in the main image output phase 320 (S34). Thereafter, the content server 20 displays the heatmap as well as the replay images in the replay image distribution phase 322 to allow reference to the heatmap as guidance during a viewpoint operation (S38).

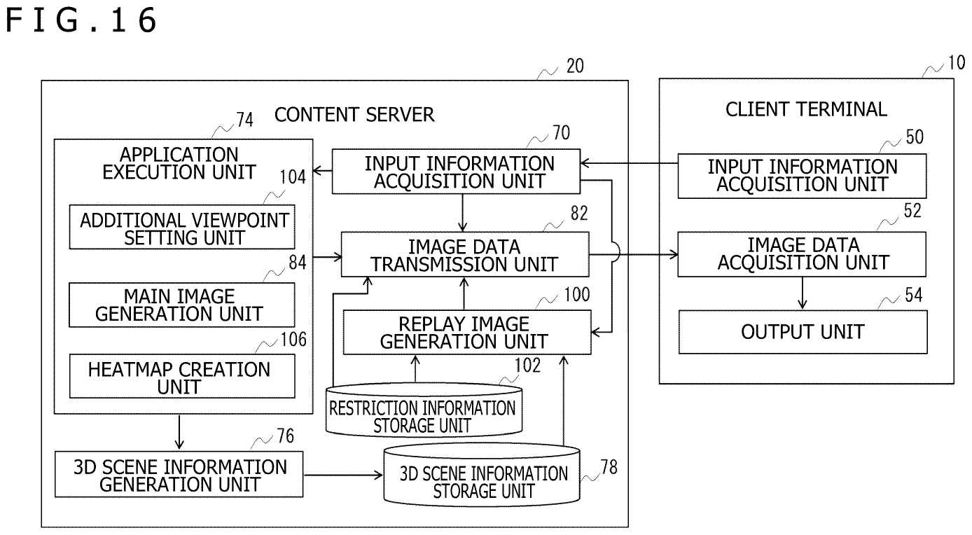

FIG. 16 illustrates a configuration of function blocks of the client terminal 10 and the content server 20 for achieving distribution of replay video. Note that blocks having functions similar to the corresponding functions of the function blocks illustrated in FIG. 6 are given the same reference signs, and the same explanation is not repeated where appropriate. Moreover, while only the one client terminal 10 is illustrated in the example in the figure, the client terminals 10 of all users participating in content are connected to the content server 20 and fulfill similar functions at least in the main image output phase.

The client terminal 10 includes the input information acquisition unit 50 for acquiring input information such as user operations, the image data acquisition unit 52 for acquiring data of images from the content server 20, and the output unit 54 for outputting data of display images. The input information acquisition unit 50 acquires details of user operations from the input device 14 as needed. Moreover, the input information acquisition unit 50 also receives an operation for requesting distribution of replay images in the replay image distribution phase 322. The input information acquisition unit 50 also acquires information associated with display viewpoints for main images or replay images from the input device 14 or a head-mounted display as needed or at predetermined time intervals. The input information acquisition unit 50 supplies the acquired information to the content server 20 as appropriate.

The image data acquisition unit 52 acquires data of display images from the content server 20. The data of the display image herein may include data of main images, data of replay images, and data of a heatmap. The output unit 54 outputs the display images acquired by the image data acquisition unit 52 to the display device 16, and causes the display device 16 to display the display images.

The content server 20 includes the input information acquisition unit 70 which acquires input information from the client terminal 10, the application execution unit 74 which executes an application such as an electronic game, the 3D scene information generation unit 76 which generates data of 3D scene information, the 3D scene information storage unit 78 which stores data of generated 3D scene information, a replay image generation unit 100 which generates replay images, the image data transmission unit 82 which transmits data of display images to the client terminal 10, and a restriction information storage unit 102 which stores restriction information associated with distribution of replay images.

The input information acquisition unit 70 acquires information associated with details of user operations and display viewpoints from the client terminal 10 as needed or at predetermined time intervals, and supplies the acquired information to the application execution unit 74. The application execution unit 74 processes an application of content, such as an electronic game, on the basis of details of user operations in the main image output phase. The application execution unit 74 includes an additional viewpoint setting unit 104, the main image generation unit 84, and a heatmap creation unit 106.

The additional viewpoint setting unit 104 additionally sets viewpoints for main images to be generated, independently of display viewpoints transmitted from the client terminal 10. The added viewpoints are similar to pseudo viewpoints in a point that the added viewpoints are not used for display in the main image output phase, but is different from pseudo viewpoints in a point that the added viewpoints considered to be necessary for generating appropriate replay images in view of the whole display world are determined according to details of content. For example, the additional viewpoint setting unit 104 sets an additional viewpoint at a place where an event is likely to occur in a roll playing game to secure accuracy of 3D scene information indicating this place.

In this manner, the additional viewpoint setting unit 104 may predict a phenomenon which can occur in the display world, and set an additional viewpoint according to the predicted phenomenon, or may additionally provide a viewpoint at such a portion where a display viewpoint is not easily located in the main image output phase in consideration of a geographical situation in the display world. The additional viewpoint setting unit 104 may further add a viewpoint which cannot be generated as a display viewpoint, such as a viewpoint for following from behind a virtual user present in the display world, a viewpoint for viewing a virtual user from diagonally above, and a viewpoint for overviewing the display world.

As apparent from above, the additional viewpoint setting unit 104 may set a fixed additional viewpoint in the display world and use the additional viewpoint as a fixed point camera, or may set an additional viewpoint movable according to a situation or movement of a virtual user. Moreover, the additional viewpoint setting unit 104 may set an additional viewpoint according to a program for specifying an application, or may receive a setting of an additional viewpoint from the user as an initial setting of the main image output phase. In any of these cases, quality of replay images can be enhanced on the basis of more accurate 3D scene information by setting additional viewpoints under various standards within the range of the processing ability of the content server 20. Moreover, the user can recheck a state caused in the display world in such positions and directions where this state is not visible in the main image output phase.

The main image generation unit 84 generates frames of main images corresponding to display viewpoints transmitted from the client terminal 10 at a predetermined rate. Moreover, the main image generation unit 84 generates images of the display world viewed from the viewpoints added by the additional viewpoint setting unit 104 at a predetermined rate. The heatmap creation unit 106 creates a heatmap which indicates a distribution of density of display viewpoint and additionally set viewpoints on the plane of the display world in the main image output phase. For example, the heatmap creation unit 106 classifies a map for overviewing the display world by color into a high-density display viewpoint region, a middle-density region, a low-density region, and a region containing no display viewpoint.

As the density of display viewpoints increases, a wider variety of training images are obtained, and more accurate 3D scene information is obtained. Accordingly, higher-quality replay images are also considered to be formed. On the contrary, in a case where no display viewpoint, or only an extremely small number of display viewpoints considered to be none are given, no 3D scene information is generated even in the state of alignment between the viewpoints and the corresponding place in the replay image distribution phase. In this case, no replay image can be displayed. Accordingly, a heatmap is created in the main image output phase, and referred to for operating the viewpoints of the replay images. In this manner, the user can easily set appropriate viewpoints.

The 3D scene information generation unit 76 generates 3D scene information which indicates scenes in respective time steps by the machine learning described above on the basis of images generated by the application execution unit 74 as training images in the main image output phase. In this case, the 3D scene information generation unit 76 may similarly extract only regions necessary for generating replay images from images generated by the main image generation unit 84, and use the extracted regions for machine learning. Moreover, the 3D scene information generation unit 76 may limit regions for which 3D scene information is to be generated in the display world on the basis of the heatmap created by the heatmap creation unit 106. Specifically, the 3D scene information generation unit 76 may designate places having higher density of display viewpoints and additional viewpoints than a threshold as targets for which 3D scene information is to be generated.

The 3D scene information storage unit 78 stores 3D scene information generated by the 3D scene information generation unit 76. The 3D scene information storage unit 78 stores data of 3D scene information generated in respective time steps in association with the time axis in the main image output phase. The replay image generation unit 100 generates replay images by volume rendering described above with use of the 3D scene information stored in the 3D scene information storage unit 78 in response to a request for distributing the replay images from the user in the replay image distribution phase. At this time, the replay image generation unit 100 acquires display viewpoints from the input information acquisition unit 70, and generates the replay images while changing the viewpoints according to the acquired display viewpoints.

In this case, the replay image generation unit 100 may limit at least either the distribution time of the replay images or the display viewpoints on the basis of restriction information stored in the restriction information storage unit 102. For example, the replay image generation unit 100 does not generate the corresponding replay images before an elapse of a predetermined time after an end of the main image output phase. In this manner, the replay image generation unit 100 reduces adverse effects such as a loss of application purchase intention as a result of early disclosure of details of content. Moreover, the replay image generation unit 100 does not generate the corresponding replay images when the display viewpoints are operated in positions or directions where display of the replay images is not desired. In this case, the replay image generation unit 100 may generate a display image representing that the display viewpoints exceed the limit.

As an initial process at the time of execution of an application, the replay image generation unit 100 reads the restriction information described above from a setting file specifying the application, or other places, and stores the restriction information in the restriction information storage unit 102. The image data transmission unit 82 transmits data of main images generated by the main image generation unit 84 to the client terminal 10 at a predetermined rate in the main image output phase. Moreover, the image data transmission unit 82 transmits data of the replay images generated by the replay image generation unit 100 to the client terminal 10 in response to a distribution request in the replay image distribution phase.

In this case, the image data transmission unit 82 may limit the distribution destination of the replay images corresponding to the 3D scene information on the basis of the restriction information stored in the restriction information storage unit 102. For example, the image data transmission unit 82 may transmit the replay images corresponding to the 3D scene information to only the client terminal 10 of the user participating in the main image output phase. The image data transmission unit 82 may transmit ordinary replay video not based on the 3D scene information to the client terminals 10 of other users. In this case, replay images are generated on the basis of predetermined display viewpoints in the main image output phase, and stored in an unillustrated storage unit. In this mode, easy disclosure of details of content is avoidable similarly to above.

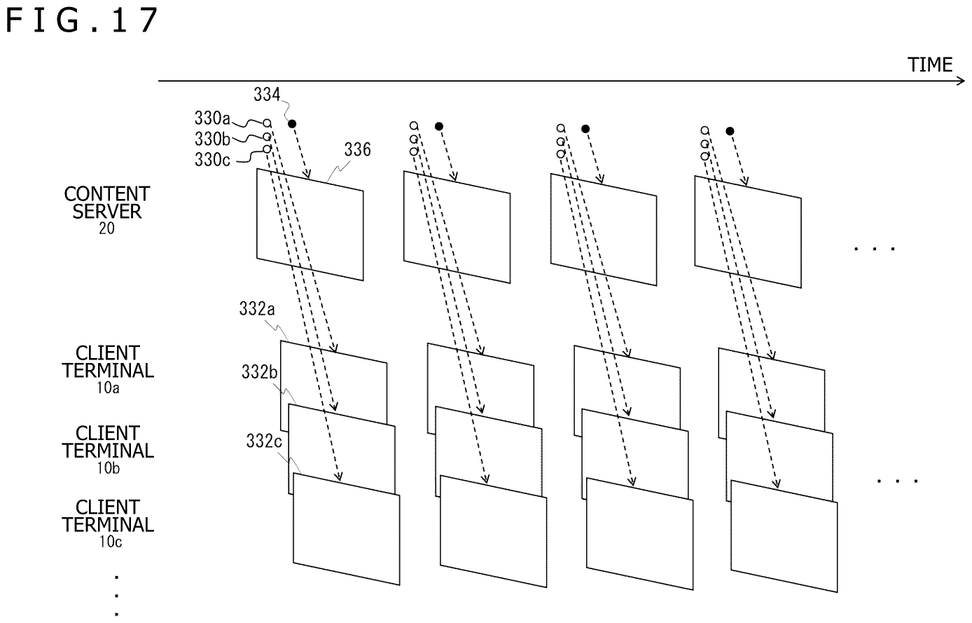

FIG. 17 schematically illustrates a sequence of images generated in the main image output phase in the present mode. This figure indicates a relation between viewpoints recognized or generated by the content server 20, and destinations of respective frames generated according to these viewpoints on an assumption that the lateral direction corresponds to the time axis. In this case, the content server 20 acquires display viewpoints (e.g., display viewpoints 330a, 330b, and 330c) from a plurality of the client terminals 10a, 10b, 10c, and others. Thereafter, the content server 20 generates frames (e.g., frames 332a, 332b, and 332c) of display images at a predetermined rate in correspondence with these display viewpoints, and transmits the generated frames to the respective client terminals 10a, 10b, 10c, and others. In this manner, each of the client terminals 10a, 10b, 10c, and others displays an image representing a state of the common display world viewed in a position or a direction where a virtual user is located, for example.

The content server 20 further generates training images (e.g., training image 336) at a predetermined rate in correspondence with viewpoints (e.g., viewpoint 334) indicated by black circles additionally set by the additional viewpoint setting unit 104. According to the example illustrated in the figure, the timing for recognizing a plurality of display viewpoints and the timing for generating viewpoints additionally set differ from each other by a short time. However, these recognition and generation may be achieved simultaneously or independently of each other in actual situations. Moreover, the additional viewpoint setting unit 104 may add a large number of viewpoints in actual situations.

The 3D scene information generation unit 76 carries out machine learning by using frames of the display images to be transmitted to the client terminal 10, and images corresponding to the additional viewpoints, designating all images as training images. For example, for an MMO (Massively Multiplayer Online) game having 100 or more players, 100 or more training images can be collected per one frame. The 3D scene information generation unit 76 therefore can increase efficiency of training image collection, raise accuracy of 3D scene information indicating scenes in respective time steps, and also easily maintain quality of replay images for changes of viewpoints.

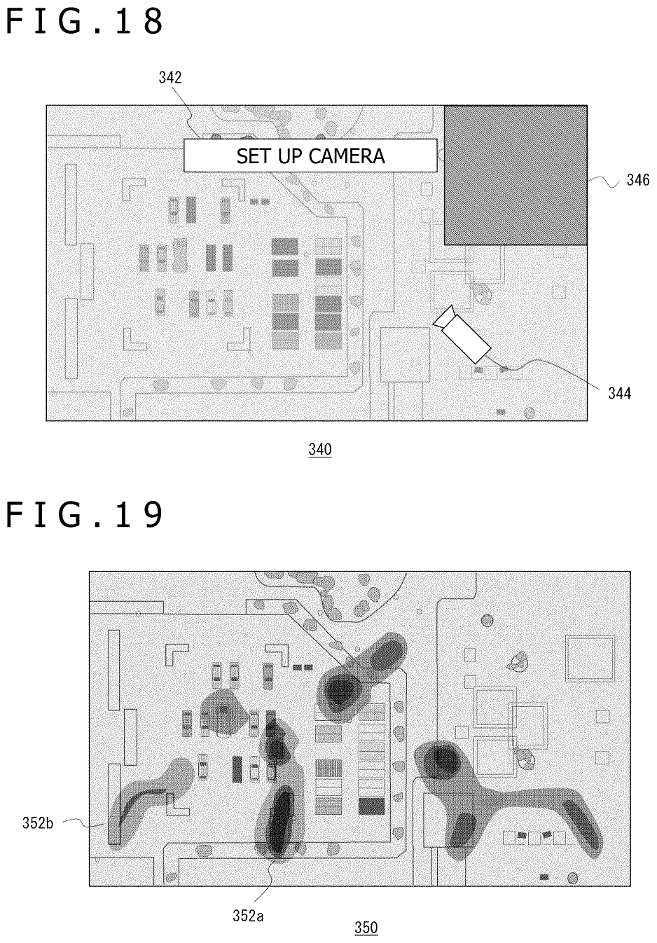

FIG. 18 illustrates an example of a screen displayed by the additional viewpoint setting unit 104 of the content server 20 to receive setting of an additional viewpoint from the user. In this example, an additional viewpoint receiving screen 340 has such a configuration which includes a map of an overview state of the display world as a base image, and also an icon 344 indicating a camera and a message 342 urging setting of an additional viewpoint, both overlapped on the map. The user shifts the icon 344 via the input device 14 by using the client terminal 10, for example, to set a desired position and a desired direction. According to setting, the additional viewpoint setting unit 104 sets an additional viewpoint aligned with the corresponding position and direction in the 3D space of the display world.

The additional viewpoint receiving screen 340 further indicates a prohibited region 346 where viewpoint setting is prohibited. The additional viewpoint setting unit 104 prohibits the user from arranging the icon 344 in the prohibited region 346. In this manner, display in a replay image, and useless generation of a training image according to a viewpoint set at an inappropriate place are avoidable. The position and the shape of the prohibited region 346 in the display world are set in an application setting file or the like beforehand. Incidentally, while the receiving screen for setting a fixed additional viewpoint has been presented in the example illustrated in the figure, the type of the additional viewpoint received from the user is not specifically limited to any type. For example, an additional viewpoint may be set behind a virtual user himself or herself in the display world. In this case, the additional viewpoint setting unit 104 may express options of types of viewpoints by characters or the like to allow the user to select and input the desired type.

FIG. 19 illustrates an example of a heatmap created by the heatmap creation unit 106 of the content server 20. In this example, a heatmap 350 displays a map indicating an overview state of the display world as a base image, and regions where display viewpoints are distributed (e.g., regions 352a and 352b) with color depths indicating levels of density, while overlapping the regions on the map. Note that levels of density may be expressed in different colors such as red, yellow, and blue in actual situations. In a case where the display viewpoints and also the regions where virtual users are present in the display world are not well-balanced as illustrated in the figure, many of these are considered as places inappropriate for generating 3D scene information. Accordingly, for example, the heatmap creation unit 106 provides a colorless region for each region where density of display viewpoints is a threshold or lower to prohibit setting of viewpoints in the replay image distribution phase.

A region corresponding to high density of display viewpoints is considered to be such a region where highly accurate 3D scene information can be generated, and to be successful as content. Accordingly, by setting display viewpoints in the place corresponding to the high-density region, the user appreciating replay images can easily enjoy the replay images for the successful scenes with high quality even in the wide display world. Note that the heatmap creation unit 106 may update the heatmap at a predetermined rate according to a change of the distribution of the display viewpoints.

In this case, the heatmap is distributed as video in synchronization with replay images during distribution of the replay images. In this manner, the user is allowed to determine appropriate display viewpoints in correspondence with a distribution change of density. This mode provides a wide movable range for a virtual user in the display world, and therefore is suited for content exhibiting an easily changeable density distribution. Meanwhile, for content providing a narrow movable range for a virtual user, for example, the heatmap creation unit 106 may integrate heatmaps obtained in respective time steps, and distribute a still image of a heatmap finally obtained.

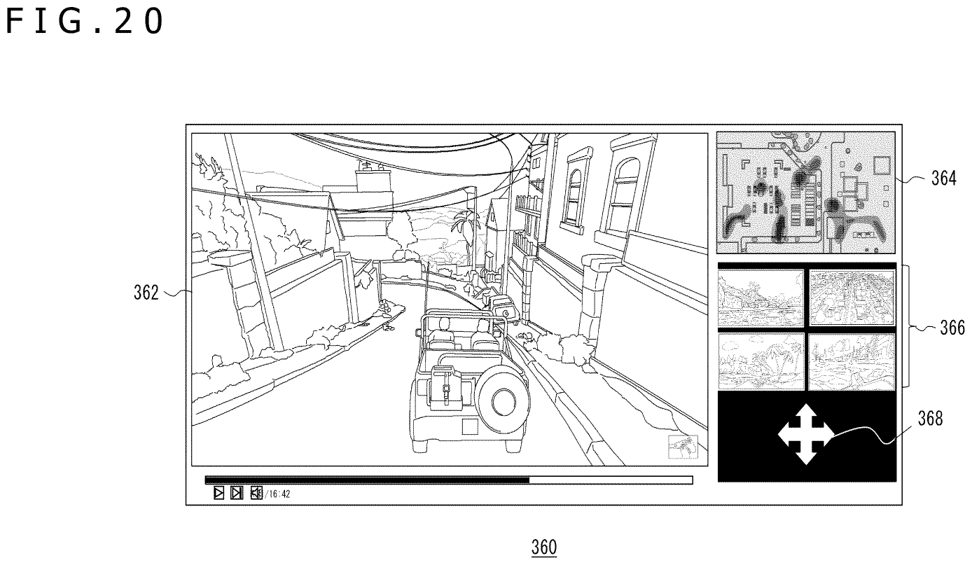

FIG. 20 illustrates an example of a display screen for a replay image displayed on the display device 16 in the replay image distribution phase. Conventionally, for viewing and listening to distribution images of a game or the like, video corresponding to specified display viewpoints is generally received by using a video viewing platform via a browser. The present embodiment is characterized by reception of viewpoint operations performed for replay images, and therefore is difficult to apply to this type of ordinary platform.

Accordingly, it is preferable to provide a unique platform equipped with a User Interface (UI) for operating viewpoints on a browser. This platform enables the user to enjoy replay images with use of a general-purpose device, such as a personal computer, a tablet terminal, and a cellular phone. In this case, the content server 20 transmits to the client terminal 10 data for which replay images, a heatmap, and a UI have been set by using a markup language such as Hyper Text Markup Language (HTML). The client terminal 10 generates a replay image display screen by using a browser, and causes the display device 16 to display this screen. Viewpoint operation information is transmitted from the client terminal 10 to the content server 20 as needed, and data corresponding to this information is transmitted from the content server 20 to the client terminal 10.

According to the example illustrated in the figure, the replay image display screen 360 includes a replay image column 362, a heatmap column 364, a candidate viewpoint column 366, and a viewpoint operation UI 368. The replay image column 362 displays replay images currently distributed. The viewpoint for a scene currently displayed can be changed by the user through operation of the viewpoint operation UI 368. In this example, the viewpoint operation UI 368 is a direction indication key configured to designate movement of the viewpoint in four directions. For example, the viewpoint moves forward in response to designation of an upward arrow portion. The viewpoint moves rightward in response to designation of a rightward arrow portion.

However, the shape and the configuration of the viewpoint operation UI 368 are not limited to these examples. For example, the position of the viewpoint and the direction of the visual line may be independently operated. In addition, an object located at the center of the field of view may be fixed, and an elevation/depression angle and an azimuth angle, or a distance may be changed relatively to this object. Moreover, the viewpoint operation UI 368 is not limited to a Graphical User Interface (GUI), and may be expressed as options indicating types of the viewpoints by characters or the like, such as a viewpoint following a main object from behind, and a viewpoint for overviewing the whole, to allow the user to select and input the desired viewpoint.

The heatmap column 364 displays a heatmap. As described above, the heatmap indicates a density distribution of display viewpoints in the main image output phase, and provides an index of the level of quality of replay images based on 3D scene information. Accordingly, designation of positions of viewpoints is enabled also through the displayed heatmap. When the user designates one spot on the heatmap by using a cursor, a touch operation, or the like not illustrated in the figure, the viewpoint of the replay image displayed in the replay image column 362 is shifted to the designated position.

On the basis of the heatmap, the user can intuitively recognize a place for which 3D scene information has not been obtained, or a place for which less accurate 3D scene information has been set. Accordingly, a successful scene can be easily appreciated with high image quality by determining the viewpoint in a high-density region. Note that the reception operation using the heatmap is not limited to designation of the viewpoint position and may be designation of the visual line direction. In this case, an icon of a camera, an arrow, or the like is superimposed on the heatmap, for example, and the visual line direction is designated by an operation for changing the direction of the icon or the arrow.

Moreover, it is considered that high-quality 3D scene information has been generated for the region corresponding to high density of display viewpoints regardless of the direction. Accordingly, the visual line may be varied in all directions for the viewpoint set in a region corresponding to highest-level density, and the movable range of the visual line direction may be limited for other regions. In a case where the viewpoint position or the visual line direction is operated using the viewpoint operation UI 368, the arrow or the like superimposed on the heatmap may be linked with this operation. In this manner, the relation between the replay image currently displayed and the viewpoint in the display world is intuitively recognizable. Moreover, in a case where the viewpoint position or the visual line direction exceeds a restriction range as a result of the viewpoint operation, a concealing object may be superimposed on the corresponding region in the field of view of the replay image currently displayed.

Note that an operation for enlarging or reducing the size of the heatmap, or shifting the display range may be received particularly in a case where the display world is wide. The candidate viewpoint column 366 displays replay images at viewpoints selected by the content server 20 on the basis of a predetermined standard as thumbnails for generally-called “recommendations.” For example, the region corresponding to the highest-level density is selected from the heatmap, and the candidate viewpoint column 366 displays replay images viewed from some of the viewpoints included in the selected region as thumbnails. Alternatively, replay images each containing a virtual user himself or herself in the display world or a predetermined player within the angle of view may be displayed. Note that the candidate viewpoint column 366 may display in the heatmap which position or direction of the viewpoint each of the replay images displayed as thumbnails is based on.

When the user selects any thumbnail image by using an unillustrated cursor, touch operation, or the like, the display viewpoint is switched to display the replay image displayed as the corresponding thumbnail in the replay image column 362. Meanwhile, in a case where a viewpoint position is designated on the heatmap, or a case where a thumbnail image is selected through the candidate viewpoint column 366, the viewpoint of the replay image displayed in the replay image column 362 until this selection may be discontinuously shifted.

In this case, the content server 20 may create a trajectory which smoothly connects the original viewpoint to a new viewpoint, shift the viewpoint along this trajectory, and display a replay image representing this shift course. For example, the content server 20 may temporarily shift the viewpoint upward to the sky, and then drop the viewpoint from the sky to the new viewpoint position. This performance can provide pleasure realizable by only replay images, and enhance quality of viewing and listening experiences.

According to the mode for distributing replay video as described above, the content server 20 collects, as training images, frames of main images transmitted to a plurality of the client terminals 10 in the main image output phase, and frames of images corresponding to additionally set viewpoints, and generates 3D scene information associated with scenes for each time step. In this manner, replay images allowed to be appreciated from arbitrary viewpoints can be distributed. Moreover, the content server 20 creates a heatmap indicating a density distribution of display viewpoints for main images concurrently with learning. The level of the density of the display viewpoints is linked with the degree of accuracy of the 3D scene information, and with the degree of successes of scenes. Accordingly, the viewpoint operation for the replay images can be achieved on the basis of the heatmap displayed simultaneously with the replay images, and the successful scenes can be easily appreciated with high image quality even for the wide display world.

Moreover, the content server 20 provides a platform enabling appreciation of replay video by using an ordinary browser, and execution of a viewpoint operation. A heatmap and a thumbnail image at a recommended viewpoint are displayed in the screen displayed by this platform together with a UI for viewpoint operations. In this manner, even in an environment where a specific type of device, such as a game device, is not provided, replay images can be appreciated by easy viewpoint operations with use of a general-purpose device.

As described above, the mode for appreciating stored scenes and replay video basically enables display from arbitrary viewpoints by learning main images of content and generating 3D scene information. Meanwhile, the method which sets additional viewpoints different from original display viewpoints outside the application execution unit, and enables a shift of arbitrary viewpoints on the basis of generated 3D scene information to acquire training images may entail a risk of exposure of the display world in excess of a visible range originally assumed by content.

For example, when the user selects a viewpoint for overviewing the display world in a replay image of a roll playing game, a place to reach in the future may become visible, and therefore pleasure for the user may be spoiled, or purchase intention of the user may be lowered. In addition, there may be not a few of viewpoints not desired by a content developer, such as a viewpoint on the opponent character side, and a viewpoint near an object in the background, depending on details of content and creating situations of images.

According to the present mode, therefore, limits are intentionally imposed on one of or both setting of viewpoints for generating training images, and setting of display viewpoints for images based on 3D scene information. For example, the content server 20 reads restriction information set by the developer from the application for each content to use the restriction information for setting viewpoints, or adds the restriction information to 3D scene information as metadata. The present mode may be combined with the mode for storing scenes, or the mode for distributing replay video described above. Accordingly, similarly to these modes, the present mode will be discussed on an assumption that the main image output phase, and the appreciation phase for an arbitrary viewpoint images based on 3D scene information are set.

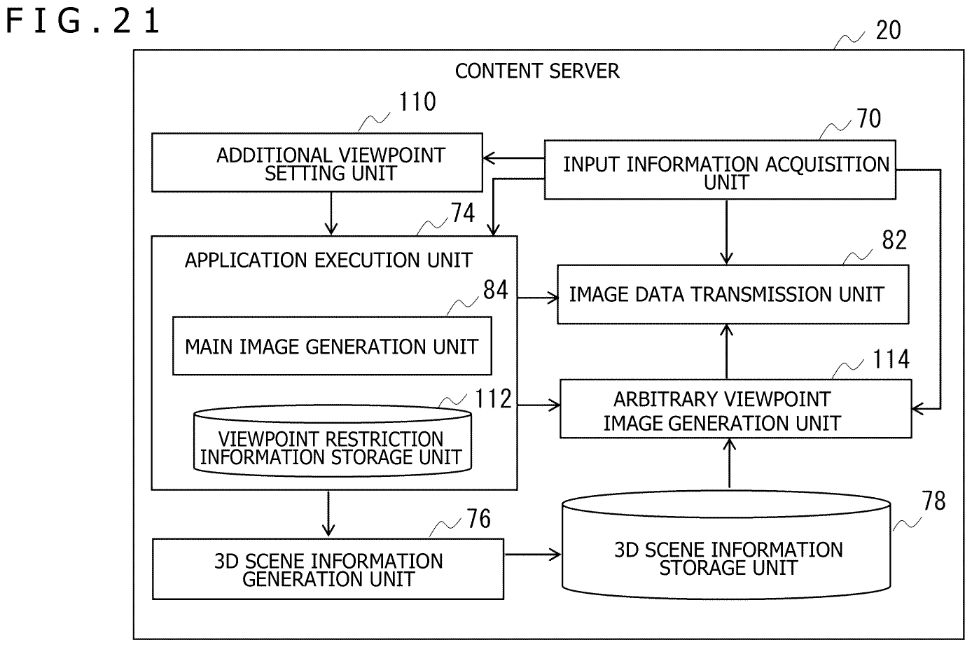

FIG. 21 illustrates a configuration of function blocks of the content server 20 in a mode for limiting display viewpoints by using an application. Note that blocks having functions similar to the corresponding functions of the function blocks illustrated in FIG. 6 are given the same reference signs, and the same explanation is not repeated where appropriate. In addition, the client terminal 10 is similar to the client terminal 10 illustrated in FIGS. 5 and 16, and therefore is not depicted in the figure. The function blocks illustrated in this figure can be combined with both the content server 20 configured to store scenes desired by the user as illustrated in FIG. 5, and the content server 20 configured to distribute replay video as illustrated in FIG. 16. Moreover, as described above, at least part of the functions illustrated in the figure may be performed by the client terminal 10. Accordingly, it is not intended that the main body performing processes be limited to the content server 20.

The content server 20 includes the input information acquisition unit 70 which acquires input information from the client terminal 10, an additional viewpoint setting unit 110 which generates viewpoints for generating training images, the application execution unit 74 which executes an application such as an electronic game, the 3D scene information generation unit 76 which generates data of 3D scene information, the 3D scene information storage unit 78 which stores data of generated 3D scene information, an arbitrary viewpoint image generation unit 114 which generates images corresponding to arbitrary viewpoints on the basis of 3D scene information, and the image data transmission unit 82 which transmits data of display images to the client terminal 10. Note that the function blocks other than the application execution unit 74 are also collectively referred to as a system part which implements peripheral processing required by the system side of the content server 20, i.e., the application execution unit 74 to execute an application.

Initially, the application execution unit 74 processes an application of content, such as an electronic game, on the basis of details of a user operation in the main image output phase. Note herein that the application execution unit 74 includes a viewpoint restriction information storage unit 112 which stores viewpoint restriction information set at the time of development of an application and associated with an application program, as well as the main image generation unit 84 for generating frames of main images. The viewpoint restriction information is information which imposes a limit on either viewpoints set at the time of generation of training images in the main image output phase, or on display viewpoints operated in the arbitrary viewpoint image output mode. The target to be limited may be either one of or both the positions of the viewpoints and the directions of the visual lines.

For example, in the development stage of content, the content server 20 provides a viewpoint restriction setting screen for an unillustrated terminal of the developer, and the developer inputs restriction information to this setting screen. The setting screen displays candidates of limiting details and requires only selection or input of only numerical values by the developer as appropriate. In this manner, time and effort for setting restriction information can be reduced. Accordingly, the developer can easily input detailed settings such as “permitting only visual lines in all directions from viewpoint positions in a range of radii from 1 m and 3 m (inclusive) from a virtual player.” The movable range of the viewpoints is not limited to a region fixed in the display world as described above, and may be a region which shifts or changes in shape according to situations. In other words, the restriction information may designate a fixed region in the display world, or specify a change of the limiting range of the viewpoints.

The input information acquisition unit 70 acquires information associated with details of user operations and display viewpoints from the client terminal 10 as needed or at predetermined time intervals. The additional viewpoint setting unit 110 has a function similar to the function of the pseudo viewpoint generation unit 72 illustrated in FIG. 5, or the additional viewpoint setting unit 104 illustrated in FIG. 16, and sets viewpoints for generating training images. In other words, the viewpoints set by the additional viewpoint setting unit 110 may be viewpoints based on display viewpoints transmitted from the client terminal 10, or viewpoints based on details of content such as the configuration of the display world.

At the time of setting, the additional viewpoint setting unit 110 reads viewpoint restriction information from the viewpoint restriction information storage unit 112 of the application execution unit 74, and sets viewpoints only in a permitted range. Alternatively, the additional viewpoint setting unit 110 may ask the application execution unit 74 whether or not viewpoints can be set via an API for each of the generated viewpoints. The additional viewpoint setting unit 110 supplies information associated with additional viewpoints set after these steps to the application execution unit 74.

The main image generation unit 84 generates images corresponding to display viewpoints transmitted from the client terminal 10, and images corresponding to viewpoints additionally set by the additional viewpoint setting unit 110, each at a predetermined rate, in the main image output phase. As described above, the additional viewpoint setting unit 110 generates additional viewpoint information in the same format as that of the viewpoint information supplied by the input information acquisition unit 70, and supplies the additional viewpoint information to the application execution unit 74. In this manner, the application execution unit 74 can generate training images by ordinary processing without a necessity of distinction between true display viewpoints and additional viewpoints.

The 3D scene information generation unit 76 generates 3D scene information associated with scenes to be stored by the machine learning described above on the basis of images generated by the application execution unit 74 as training images. The 3D scene information storage unit 78 stores 3D scene information generated by the 3D scene information generation unit 76. The arbitrary viewpoint image generation unit 114 generates images corresponding to arbitrary viewpoints by volume rendering described above on the basis of 3D scene information stored in the 3D scene information storage unit 78 in the appreciation phase for the arbitrary viewpoint images.

In this case, the arbitrary viewpoint image generation unit 114 acquires display viewpoints from the input information acquisition unit 70, and generates the arbitrary viewpoint images according to the display viewpoints while changing the viewpoints. At the time of generating images, the arbitrary viewpoint image generation unit 114 reads viewpoint restriction information from the viewpoint restriction information storage unit 112 of the application execution unit 74, and generates images corresponding to only viewpoints within a permitted range. Alternatively, the arbitrary viewpoint image generation unit 114 may ask the application execution unit 74 whether or not display viewpoints can be set via an API for each of the display viewpoints.

The range for which additional viewpoints are not permitted to be set in the main image output phase is a range lacking a sufficient number of training images, and therefore 3D scene information associated with that range is considered to be less accurate. Accordingly, generation of display images corresponding to viewpoints included in that range is prohibited also during generation of the arbitrary viewpoint images. This limitation can eliminate problems such as a sudden drop of quality of images newly entering the field of view in accordance with a viewpoint operation. On the contrary, even when a limit imposed on display viewpoints is cancelled by any fraud operation, the state of the region is not visually recognized in detail under the condition that additional viewpoints used for generation of training images are not allowed to be set to prohibit generation of detailed 3D scene information associated with that region.

As described above, the viewpoint restriction information imposes limits on both viewpoints set for generation of training images, and display viewpoints operated during generation of the arbitrary viewpoint images. In this manner, a risk of display of the display world at an angle of view not desired by the content developer can be further lowered. However, it is not intended that the present embodiment be limited to this example as described above. The limit may be imposed on only one of these types of viewpoints. Note that the arbitrary viewpoint image generation unit 114 may stop a shift of display viewpoints transmitted from the client terminal 10 when the display viewpoints reach a boundary of the restriction range in the appreciation phase for the arbitrary viewpoint images. Alternatively, the arbitrary viewpoint image generation unit 114 may conceal a region of an image newly entering the field of view at the time of excess of the restriction range by superimposing an object for concealing, for example.

The image data transmission unit 82 transmits data of main images generated by the main image generation unit 84 to the client terminal 10 at a predetermined rate in the main image output phase. The image data transmission unit 82 also transmits data of the arbitrary viewpoint images generated by the arbitrary viewpoint image generation unit 114 to the client terminal 10 in the appreciation phase for the arbitrary viewpoint images.

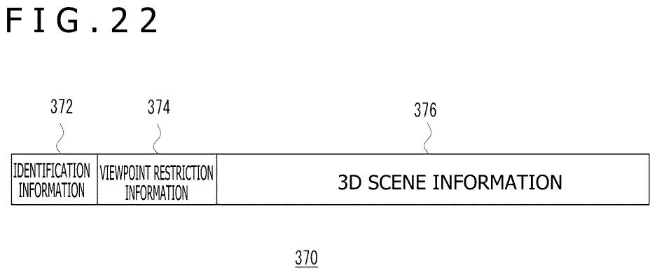

Note that the 3D scene information generation unit 76 may read viewpoint restriction information from the viewpoint restriction information storage unit 112, and store the read information in the 3D scene information storage unit 78 as metadata of generated 3D scene information. FIG. 22 illustrates an example of a data structure of display 3D scene information according to the present mode. Display 3D scene information data 370 includes an identification information field 372, a viewpoint restriction information field 374, and a 3D scene information field 376. The identification information field 372 stores various types of information for identifying 3D scene information, such as an identification number of 3D scene information, identification information associated with original content, and identification information associated with the user requesting generation.

The viewpoint restriction information field 374 stores viewpoint restriction information read by the 3D scene information generation unit 76 from the viewpoint restriction information storage unit 112. The 3D scene information field 376 stores a main part of 3D scene information generated by the 3D scene information generation unit 76. In this case, the arbitrary viewpoint image generation unit 114 initially refers to the identification information field 372 to identify 3D scene information corresponding to a request from the user, and reads the 3D scene information from the 3D scene information storage unit 78. The arbitrary viewpoint image generation unit 114 further reads viewpoint restriction information from the viewpoint restriction information field 374 and checks appropriateness of display viewpoints. If the display viewpoints fall within the restriction range, display image are generated with reference to 3D scene information stored in the 3D scene information field 376.

This correspondence between 3D scene information and viewpoint restriction information allows the arbitrary viewpoint image generation unit 114 to generate the arbitrary viewpoint images while imposing appropriate limits on viewpoints even in an environment where the application execution unit 74 is absent. Alternatively, even in a mode for transmitting the display 3D scene information data 370 itself to the client terminal 10 or the different content server 20, or storing the display 3D scene information data 370 in a recording medium for distribution, limits of viewpoints desired by the original content developer are maintained by the function of the arbitrary viewpoint image generation unit 114 included in a device used for display of the arbitrary viewpoint images.

According to the present mode described above, restriction information associated with viewpoints is set in consideration of details of content or the like at the time of development of this content. In this manner, unintended display of images in a field of view not desired by the content developer can be avoided at the time of setting of viewpoints for training images outside the application execution unit 74, or generation of display images corresponding to arbitrary viewpoints on the basis of 3D scene information obtained by learning. Moreover, restriction information added to 3D scene information can impose limits on viewpoints during display regardless of the environment of image display based on the 3D scene information.

The present disclosure has been described on the basis of the exemplary embodiment. The above embodiment has been presented only by way of example, and it is therefore understood by those skilled in the art that various modifications may be made for combinations of respective constituent elements and respective processes of these embodiments, and that modifications thus formed are also included in the scope of the present disclosure.

As apparent from above, the present disclosure is available for various types of information processing devices such as content servers, game devices, head-mounted displays, display devices, portable terminals, and personal computers, image display systems including any one of these, and others.

What is claimed is:

1. An image processing device comprising:
one or more memory devices configured to store an application program;
one or more processors configured to:
execute the application program; and
generate, at a predetermined rate, a frame of a display image representing a three-dimensional display world where a situation changes in accordance with a user operation; and
generate a training image different from the display image and representing the display world;
perform a process including generating and using, for display, three-dimensional scene information indicating three-dimensional information of the display world by machine learning that uses the training image as supervised data; and
limit a viewpoint set for the display world in the process based on viewpoint restriction information associated with the application program.

2. The image processing device according to claim 1, wherein the one or more processors are configured to:
set a viewpoint within a restriction range indicated by the viewpoint restriction information; and
generate the training image based on the viewpoint.

3. The image processing device according to claim 1, wherein the one or more processors are configured to generate, based on of the three-dimensional scene information, a display image representing a view of the display world as viewed from an arbitrary viewpoint within a restriction range indicated by the viewpoint restriction information.

4. The image processing device according to claim 1, wherein the one or more processors are configured to:
generate a display image representing a view of the display world as viewed from an arbitrary viewpoint based on of the three-dimensional scene information; and
superimpose a concealing object on a region included in the display image and corresponding to an image that newly enters a field of view when the viewpoint is beyond a restriction range indicated by the viewpoint restriction information to conceal the region.

5. The image processing device according to claim 1, wherein the one or more processors are configured to:
generate the three-dimensional scene information by the machine learning; and
store the three-dimensional scene information in the one or more storage device in association with the viewpoint restriction information as metadata.

6. The image processing device according to claim 1, wherein the one or more processors are configured to change a restriction range of a viewpoint set for the display world according to a situation based on the viewpoint restriction information indicative of a change of the restriction range of the viewpoint.

7. The image processing device according to claim 1, wherein the one or more processors are configured to generate a density map representing a spatial distribution of the training images within the three-dimensional display world, identify a first region within the three-dimensional display world where a frequency of the training images is below a threshold value, and dynamically update the viewpoint restriction information to exclude the first region from a permitted rendering range.

8. An image processing device comprising:
a storage device configured to store three-dimensional scene information including a neural network representing three-dimensional information of a display world, and viewpoint restriction information associated with the three-dimensional scene information, the three-dimensional scene information and the viewpoint restriction information being associated with each other in the storage device; and
one or more processors configured to read the three-dimensional scene information and the viewpoint restriction information from the storage device, and further configured to generate, by volume rendering using the three-dimensional scene information, a display image representing a view of the display world as viewed from an arbitrary viewpoint within a restriction range indicated by the viewpoint restriction information.

9. A method comprising:
executing an application program;
generating, at a predetermined rate, a frame of a display image representing a three-dimensional display world where a situation changes in accordance with a user operation;
generating a training image different from the display image and representing the display world; and
performing a process including:
generating and using, for display, three-dimensional scene information indicating three-dimensional information associated with the display world by machine learning that uses the training image as supervised data; and
limiting a viewpoint set for the display world based on viewpoint restriction information associated with the application program.

10. The method of claim 9, further comprising:
setting a viewpoint within a restriction range indicated by the viewpoint restriction information; and
generating the training image based on the viewpoint.

11. The method of claim 9, further comprising generating, based on of the three-dimensional scene information, a display image representing a view of the display world as viewed from an arbitrary viewpoint within a restriction range indicated by the viewpoint restriction information.

12. The method of claim 9, further comprising:
generating a display image representing a view of the display world as viewed from an arbitrary viewpoint based on of the three-dimensional scene information; and
superimposing a concealing object on a region included in the display image and corresponding to an image that newly enters a field of view when the viewpoint is beyond a restriction range indicated by the viewpoint restriction information to conceal the region.

13. The method of claim 9, further comprising:
generating the three-dimensional scene information by the machine learning; and
storing the three-dimensional scene information in the one or more storage device in association with the viewpoint restriction information as metadata.

14. The method of claim 9, further comprising changing a restriction range of a viewpoint set for the display world according to a situation based on the viewpoint restriction information indicative of a change of the restriction range of the viewpoint.

15. A non-transitory computer-readable medium storing computer-readable instructions that, when executed by a computer, cause the computer to perform operations comprising:
executing an application program;
generating, at a predetermined rate, a frame of a display image representing a three-dimensional display world where a situation changes in accordance with a user operation;
generating a training image different from the display image and representing the display world; and
performing a process including:
generating and using, for display, three-dimensional scene information indicating three-dimensional information associated with the display world by machine learning that uses the training image as supervised data; and
limiting a viewpoint set for the display world based on viewpoint restriction information associated with the application program.

16. The non-transitory computer-readable medium of claim 15, wherein the operations further comprise:
setting a viewpoint within a restriction range indicated by the viewpoint restriction information; and
generating the training image based on the viewpoint.

17. The non-transitory computer-readable medium of claim 15, wherein the operations further comprise generating, based on of the three-dimensional scene information, a display image representing a view of the display world as viewed from an arbitrary viewpoint within a restriction range indicated by the viewpoint restriction information.

18. The non-transitory computer-readable medium of claim 15, wherein the operations further comprise:
generating a display image representing a view of the display world as viewed from an arbitrary viewpoint based on of the three-dimensional scene information; and
superimposing a concealing object on a region included in the display image and corresponding to an image that newly enters a field of view when the viewpoint is beyond a restriction range indicated by the viewpoint restriction information to conceal the region.

19. The non-transitory computer-readable medium of claim 15, wherein the operations further comprise:
generating the three-dimensional scene information by the machine learning; and
storing the three-dimensional scene information in the one or more storage device in association with the viewpoint restriction information as metadata.

20. The non-transitory computer-readable medium of claim 15, wherein the operations further comprise changing a restriction range of a viewpoint set for the display world according to a situation based on the viewpoint restriction information indicative of a change of the restriction range of the viewpoint.
